(19) United States
(12) Patent Application Publication
(10) Pub. No.: US 2026/0145454 A1
(43) Pub. Date: May 28, 2026

(54) LIQUID EJECTING HEAD

(71) Applicant: SEIKO EPSON CORPORATION, Tokyo (JP)

(72) Inventors: Kenji SATO, SHIOJIRI-SHI (JP); Yusuke ISHII, SHIOJIRI-SHI (JP)

(21) Appl. No.: 19/396,634

(22) Filed: Nov. 21, 2025

(30) Foreign Application Priority Data
Nov. 25, 2024 (JP) 2024-204492

(51) Int. Cl. B41J 29/42; B41J 2/14; B41J 2/16; B41J 29/12

(52) U.S. Cl. CPC B41J 29/42; B41J 2/1433; B41J 2/1623; B41J 29/12

(57) ABSTRACT

A liquid ejecting head includes: a first member, a second member, and a first sealing material disposed between the first member and the second member, the first sealing material includes a second layer exposed to an outside of the liquid ejecting head and a first layer not exposed to the outside of the liquid ejecting head by being covered with the second layer, and a color of the first layer and a color of the second layer are different from each other.

The present application is based on, and claims priority from JP Application Serial Number 2024-204492, filed Nov. 25, 2024, the disclosure of which is hereby incorporated by reference herein in its entirety.

### BACKGROUND

### 1. Technical Field

The present disclosure relates to a liquid ejecting head.

### 2. Related Art

In a liquid ejecting head that ejects liquid such as ink in an apparatus such as an ink jet printer, the gap between two or more members is filled with a sealing material in some cases. For example, a liquid ejecting head described in JP-A-2017-121760 includes nozzle plates each having a plurality of nozzles and a fixing plate having openings surrounding the nozzle plates, and the gaps between the nozzle plates and peripheral edges of the openings of the fixing plate are filled with a molding material.

In the liquid ejecting head described in JP-A-2017-121760, the molding material can deteriorate due to adhesion of ink, and as a result, it can cause a sealing failure of the molding material. In such a situation, it is required that a state in which a sealing failure of a sealing material is likely to occur can be detected before a problem occurs in the liquid ejecting head due to the sealing failure of the molding material.

### SUMMARY

To solve the problem described above, a liquid ejecting head according to a preferred aspect of the present disclosure includes: a first member; a second member; and a first sealing material disposed between the first member and the second member, the first sealing material includes a second layer exposed to an outside of the liquid ejecting head and a first layer not exposed to the outside of the liquid ejecting head by being covered with the second layer, and a color of the first layer and a color of the second layer are different from each other.

A liquid ejecting head according to another preferred aspect of the present disclosure includes: a first member having a through hole; and a first sealing material disposed in the through hole, the first sealing material includes a second layer exposed to an outside of the liquid ejecting head and a first layer not exposed to the outside of the liquid ejecting head by being covered with the second layer, and a color of the first layer and a color of the second layer are different from each other.

### BRIEF DESCRIPTION OF THE DRAWINGS

FIG. 1 is a schematic diagram illustrating a configuration example of a liquid ejecting apparatus including liquid ejecting heads.

FIG. 2 is a perspective view of a head module including the liquid ejecting heads according to an embodiment.

FIG. 3 is an exploded perspective view of the liquid ejecting head according to the embodiment.

FIG. 4 illustrates a part of the cross-sectional view taken along line IV-IV in FIG. 3.

FIG. 5 is a bottom view of the liquid ejecting head according to the first embodiment.

FIG. 6 is an explanatory view of a sealing material disposed between a nozzle plate and a fixing plate.

FIG. 7 is an explanatory view of the sealing material illustrated in FIG. 6, illustrating its effect.

FIG. 8 is an explanatory view of a sealing material disposed between a holder and the fixing plate.

FIG. 9 is an explanatory view of a sealing material disposed in a through hole of the fixing plate and a through hole of a reinforcing plate.

FIG. 10 is a side view of the liquid ejecting head according to the embodiment.

FIG. 11 is an explanatory view of a sealing material disposed between a cover and the holder.

FIG. 12 is an explanatory view of the cover and a flow-path tube.

FIG. 13 is an explanatory view of a sealing material disposed between the cover and the flow-path tube.

### DESCRIPTION OF EMBODIMENTS

Hereinafter, a preferred embodiment according to the present disclosure will be described with reference to the accompanying drawings. In the drawings, the dimensions and scales of each portion are different from actual ones as appropriate, and some parts are schematically illustrated for ease of understanding. In addition, the scope of the present disclosure is not limited to the following configurations unless otherwise specified as limiting the present disclosure.

For convenience, an X-axis, a Y-axis, and a Z-axis intersecting each other will be used as appropriate in the following description. Hereinafter, one direction along the X-axis will be referred to as an X1 direction, and a direction opposite to the X1 direction will be referred to as an X2 direction. Similarly, directions opposite to each other along the Y-axis are a Y1 direction and a Y2 direction. Further, directions opposite to each other along the Z-axis are a Z1 direction and a Z2 direction.

The Z1 direction is an example of a “first direction” in a case where a sealing material 85 described later is regarded as an example of a “first sealing material”. The Z2 direction is an example of a “first direction” in a case where a sealing material 81, 82, or 83 described later is regarded as an example of a “first sealing material”. A direction intersecting the Z-axis and extending from the inside to the outside of a liquid ejecting head 1 described later is an example of a “first direction” in a case where a sealing material 84 described later is regarded as an example of a “first sealing material”.

However, typically, the Z-axis is the vertical axis, and the Z2 direction corresponds to the downward direction in the vertical direction. However, the Z-axis is not limited to the vertical axis. The X-axis, the Y-axis, and the Z-axis are typically orthogonal to each other, but are not limited thereto, and need only intersect each other at an angle within a range of from, for example, 80° or more to 100° or less.

### 1. First Embodiment

### 1-1. Schematic Configuration of Liquid Ejecting Apparatus

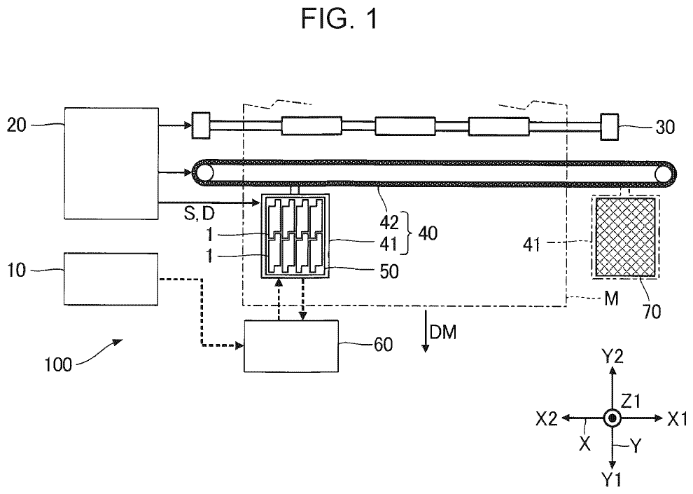

FIG. 1 is a schematic diagram illustrating a configuration example of a liquid ejecting apparatus 100 including the liquid ejecting head 1. The liquid ejecting apparatus 100 is an ink jet printing apparatus that ejects ink which is an example of “liquid” to a medium M as droplets. The medium M is typically a printing sheet. The medium M is not limited to a printing sheet and may be, for example, a printing target of any material such as a resin film or a cloth.

As illustrated in FIG. 1, the liquid ejecting apparatus 100 includes a liquid container 10, a control unit 20, a transport mechanism 30, a movement mechanism 40, a head module 50, a circulation mechanism 60, and a wiping member 70. Hereinafter, all of these will be briefly described in order with reference to FIG. 1.

The liquid container 10 stores ink. Examples of specific aspects of the liquid container 10 include a cartridge which can be attached to and detached from the liquid ejecting apparatus 100, a bag-shaped ink pack which is formed of a flexible film, and an ink tank that can be replenished with ink. A type of ink stored in the liquid container 10 is not particularly limited, and may be selected as appropriate.

The control unit 20 includes, for example, a processing circuit such as a central processing unit (CPU) or a field programmable gate array (FPGA) and a storage circuit such as a semiconductor memory, and controls the operation of each element of the liquid ejecting apparatus 100.

The transport mechanism 30 transports the medium M in a transport direction DM, which is the Y1 direction, under the control of the control unit 20. The movement mechanism 40 reciprocates the head module 50 in the X1 direction and the X2 direction under the control of the control unit 20. In the example illustrated in FIG. 1, the movement mechanism 40 includes a substantially box-shaped transport unit 41 called a carriage which houses the head module 50, and a transport belt 42 to which the transport unit 41 is fixed. In addition to the head module 50, the liquid container 10 described above may be mounted on the transport unit 41.

In the present embodiment, the movement mechanism 40 not only reciprocates the head module 50 along the X-axis in a range over the entire width of the medium M but also can move the head module 50 to a position overlapping the wiping member 70 when viewed in the direction along the Z-axis.

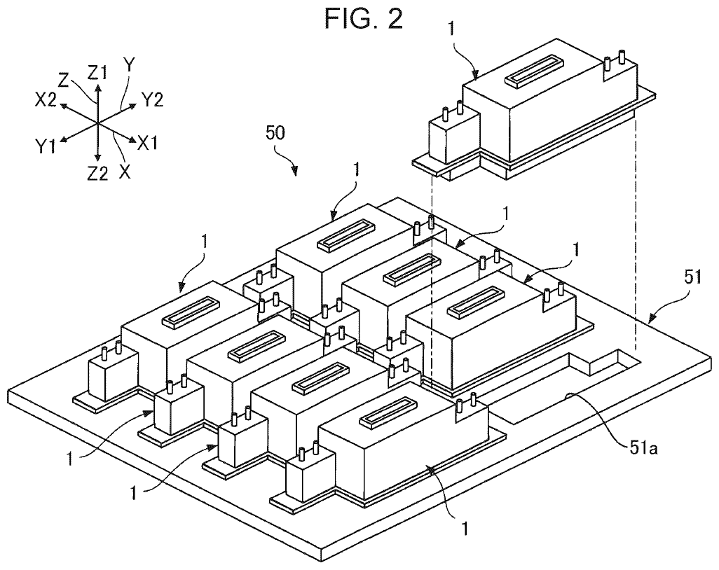

The head module 50 ejects the ink supplied from the liquid container 10 via the circulation mechanism 60 onto the medium M in the Z2 direction from each of the plurality of nozzles under the control of the control unit 20. The ejection is performed in parallel with the transport of the medium M by the transport mechanism 30 and the reciprocating movement of the head module 50 by the movement mechanism 40, and thus an image is formed on the surface of the medium M with ink. The head module 50 has a plurality of liquid ejecting heads 1. Details of the liquid ejecting head 1 will be described later with reference to FIGS. 2 to 13.

In the example illustrated in FIG. 1, the liquid container 10 is connected to the head module 50 via the circulation mechanism 60. The circulation mechanism 60 is a mechanism that supplies ink to the head module 50 and that collects the ink discharged from the head module 50 for resupply to the head module 50. By the operation of the circulation mechanism 60, it is possible to suppress an increase in the viscosity of the ink and to reduce the retention of air bubbles in the ink. The circulation mechanism 60 may be provided as necessary or may be omitted. That is, the liquid ejecting apparatus 100 is not limited to having a configuration of circulating ink in the liquid ejecting heads 1.

The wiping member 70 is a member for wiping surfaces of nozzle plates 18c and surfaces of fixing plates 14 of the liquid ejecting heads 1, which will be described later. The wiping member 70 is, for example, a member made of a fiber material such as a woven fabric or a nonwoven fabric or a porous material such as a sponge, or a blade-shaped member made of an elastic material such as rubber. The wiping member 70 is disposed at a position deviated from the transport region of the medium M in the direction along the X-axis. When the wiping member 70 wipes the nozzle plates 18c and the fixing plates 14, the movement mechanism 40 positions the liquid ejecting head 1 at a position overlapping the wiping member 70 when viewed in the direction along the Z-axis. In this state, wiping or cleaning is performed by wiping the nozzle plates 18c and the fixing plates 14 with the wiping member 70. In this process, the liquid ejecting head 1 may move in the direction along the X-axis relative to the wiping member 70 by the driving of the movement mechanism 40, or the wiping member 70 may move in the direction along the X-axis or the Y-axis relative to the liquid ejecting head 1 by the driving of a mechanism other than the movement mechanism 40.

In addition, the wiping member 70 may collectively wipe the nozzle plates 18c of the plurality of liquid ejecting heads 1, or may selectively and individually wipe the nozzle plates 18c of one liquid ejecting head 1 among the plurality of liquid ejecting heads 1. In addition, the aspect of the wiping member 70 such as the size, the shape, and the location is not limited to the example illustrated in FIG. 1, and may be in any suitable configuration. For example, the wiping member 70 may be disposed at a position deviated from the transport region of the medium M in the X2 direction, or may have a configuration including a plurality of wiping members each provided for the corresponding liquid ejecting head 1. At the position where the wiping member 70 is provided, a mechanism that performs suction cleaning in which ink is discharged from the nozzles N of the liquid ejecting heads 1 by suction, a mechanism that performs capping in which all of the nozzles N of the liquid ejecting heads 1 are capped, and the like may be provided, in addition to the wiping member 70.

### 1-2. Liquid Ejecting Head

FIG. 2 is a perspective view of the head module 50 including the liquid ejecting heads 1 according to the embodiment. As illustrated in FIG. 2, the head module 50 includes a support 51 and the plurality of liquid ejecting heads 1.

The support 51 is a plate-like member that supports the plurality of liquid ejecting heads 1. The support 51 is provided with a plurality of mounting holes 51a. Each liquid ejecting head 1 is fixed to the support 51 by screwing or the like in a state of being inserted into one of the mounting holes 51a. The plurality of liquid ejecting heads 1 are arranged in a matrix along the X-axis and the Y-axis.

The number and arrangement of the liquid ejecting heads 1 included in the head module 50 are not limited to the example illustrated in FIG. 2, and may be in any suitable configuration. In addition, the shape of the support 51 is not limited to the example illustrated in FIG. 2 and may be in any suitable configuration.

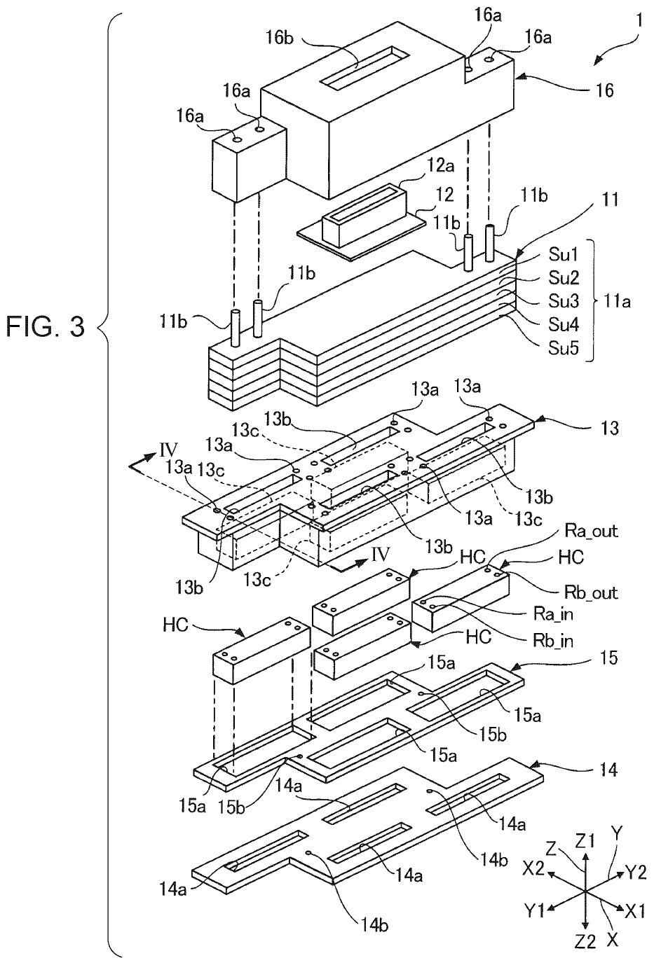

FIG. 3 is an exploded perspective view of the liquid ejecting head 1 according to the embodiment. As illustrated in FIG. 3, the liquid ejecting head 1 includes a flow-path structure 11, a wiring substrate 12, a holder 13, four head chips HC, a fixing plate 14, a reinforcing plate 15, and a cover 16. The cover 16, the wiring substrate 12, the flow-path structure 11, the holder 13, the four head chips HC, the reinforcing plate 15, and the fixing plate 14 are arranged in this order in the Z2 direction.

Here, the holder 13 is an example of a “first member” or a “second member” in a case where the sealing material 82 described later is regarded as an example of a “first sealing material”. In addition, the holder 13 is an example of a “first member” or a “second member” in a case where the sealing material 84 described later is regarded as an example of a “first sealing material”. The fixing plate 14 is an example of a “first member” or a “second member” in a case where the sealing material 81 described later is regarded as an example of a “first sealing material”. In addition, the fixing plate 14 is an example of a “first member” or a “second member” in a case where the sealing material 82 described later is regarded as an example of a “first sealing material”. The cover 16 is an example of a “first member” or a “second member” in a case where the sealing material 85 described later is regarded as an example of a “first sealing material”. In addition, the cover 16 is an example of a “first member” or a “second member” in a case where the sealing material 84 described later is regarded as an example of a “first sealing material”. Further, the cover 16 is an example of a “first member” or a “second member” in a case where the sealing material 85 described later is regarded as an example of a “first sealing material”. A multilayer body including the fixing plate 14 and the reinforcing plate 15 is an example of a “first member” in a case where the sealing material 83 described later is regarded as a “first sealing material”. Note that, in a case where the sealing material 83 described later is regarded as a “first sealing material”, the fixing plate 14 may be regarded as an example of a “first member”.

Hereinafter, the outline of each portion of the liquid ejecting head 1 will be described in order with reference to FIG. 3.

The flow-path structure 11 is a structure in which flow paths for supplying ink from the circulation mechanism 60 to the four head chips HC are provided. The flow-path structure 11 includes a flow-path member 11a and four flow-path tubes 11b. Each flow-path tube 11b is an example of a “first member” or a “second member” in a case where the sealing material 85 described later is regarded as a “first sealing material”.

Although not illustrated in FIG. 3, supply flow paths for supplying ink to the four head chips HC and discharge flow paths for discharging ink from the four head chips HC are provided in the flow-path member 11a. In this manner, the flow-path member 11a has flow paths which communicate with nozzles N described later.

The flow-path member 11a has a plurality of substrates Su1 to Su5, and these layers are stacked in this order in the Z2 direction. Each of the substrates Su1 to Su5 is made of, for example, a resin material such as zylon, polyphenylene sulfide (PPS), or polypropylene (PP), and is formed by injection-molding. “Zylon” is a registered trademark. In addition, the plurality of substrates Su1 to Su5 are bonded to one another by, for example, an adhesive such as an epoxy-based adhesive. The number, thicknesses, and the like of the substrates forming the flow-path member 11a are not limited to the example illustrated in FIG. 3, and may be in any suitable configuration.

Each of the flow-path tubes 11b is a tube protruding from a surface of the flow-path member 11a facing the Z1 direction, and connects the outside of the liquid ejecting head 1 and a flow path of the flow-path member 11a. Of the four flow-path tubes 11b, each of two flow-path tubes 11b is connected to a supply flow path mentioned above, and each of the remaining two flow-path tubes 11b is connected to a discharge flow path mentioned above.

The wiring substrate 12 is a mounting component for electrically coupling the liquid ejecting head 1 to the control unit 20. The wiring substrate 12 is formed of, for example, a flexible wiring substrate or a rigid wiring substrate. The wiring substrate 12 is disposed on the flow-path structure 11, and the flow-path structure 11 faces a surface of the wiring substrate 12 facing the Z2 direction. A connector 12a is provided on a surface of the wiring substrate 12 facing the Z1 direction. The connector 12a is a coupling component for electrically coupling the liquid ejecting head 1 and the control unit 20. In addition, although not illustrated, wiring coupled to the four head chips HC is coupled to the wiring substrate 12. The wiring is formed of, for example, a combination of a flexible wiring substrate and a rigid wiring substrate. The wiring may be formed integrally with the wiring substrate 12.

The holder 13 is a structure that houses and supports the four head chips HC. The holder 13 is made of, for example, a resin material or a metal material. The holder 13 is provided with a plurality of holder flow paths 13a, a plurality of wiring holes 13b, and a plurality of recesses 13c. Each of the plurality of holder flow paths 13a is a hole for ink to flow between a head chip HC and the flow-path structure 11. A holder flow path 13a is provided corresponding to each of inlets Ra_in and Rb_in and outlets Ra_out and Rb_out described later. Each of the plurality of wiring holes 13b is a hole through which wiring (not illustrated) coupling a head chip HC and the wiring substrate 12 is passed. Each of the plurality of recesses 13c has an opening 13d which is open to and facing the Z2 direction, and the recesses 13c are spaces in which the head chips HC are disposed.

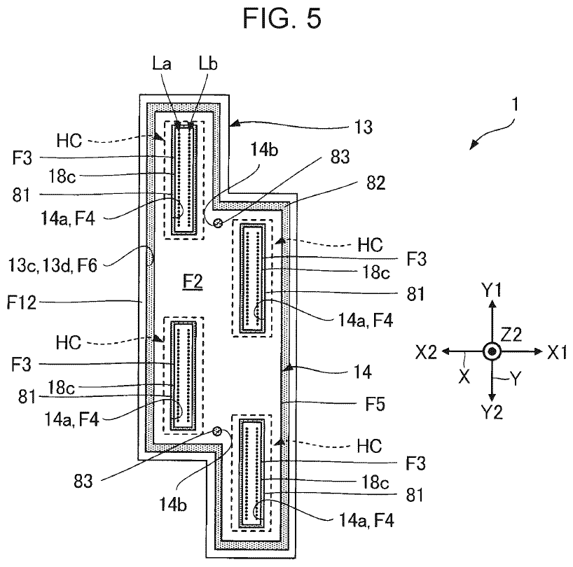

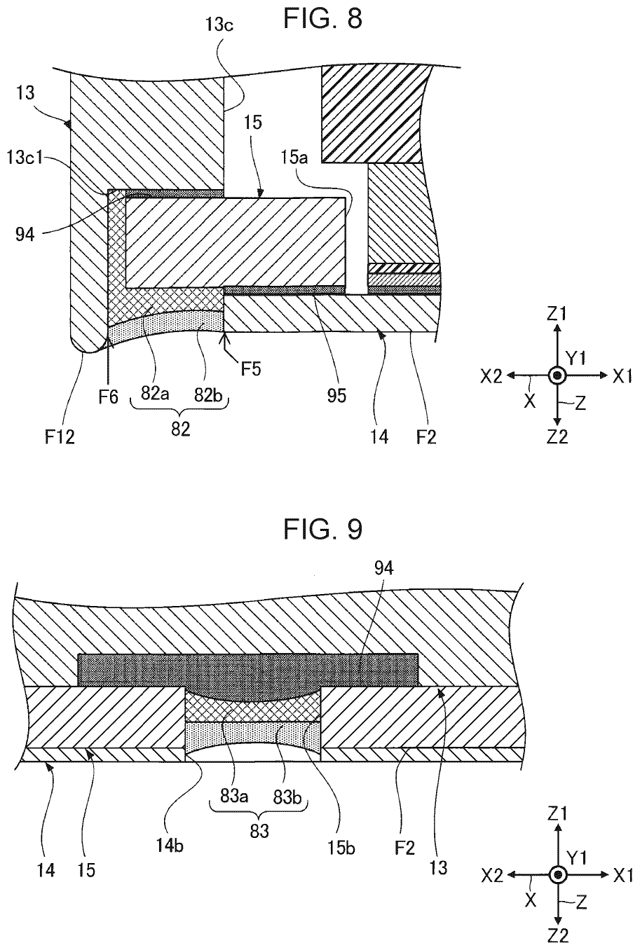

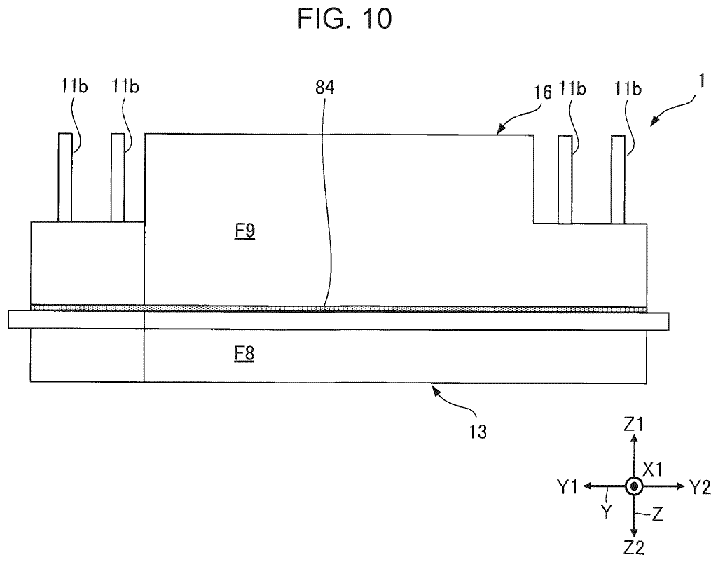

Here, the holder 13 has a surface F8 that faces a direction intersecting the Z-axis and extending from the inside to the outside of the liquid ejecting head 1 as illustrated in FIGS. 10 and 11 described later. The surface F8 is an example of a “first surface” or a “second surface” in a case where the sealing material 84 described later is regarded as an example of a “first sealing material”. The surface F8 is a part of the outer wall surfaces of the holder 13 and serves as a part of the outer surfaces of the liquid ejecting head 1. Further, the holder 13 has a surface F12 facing the Z2 direction as illustrated in FIG. 8 described later. The surface F12 is an example of a “first surface” or a “second surface” in a case where the sealing material 82 described later is regarded as an example of a “first sealing material”. Further, the holder 13 has an inner peripheral surface F6 of the recesses 13c as illustrated in FIG. 5 described later. The inner peripheral surface F6 defines the openings 13d.

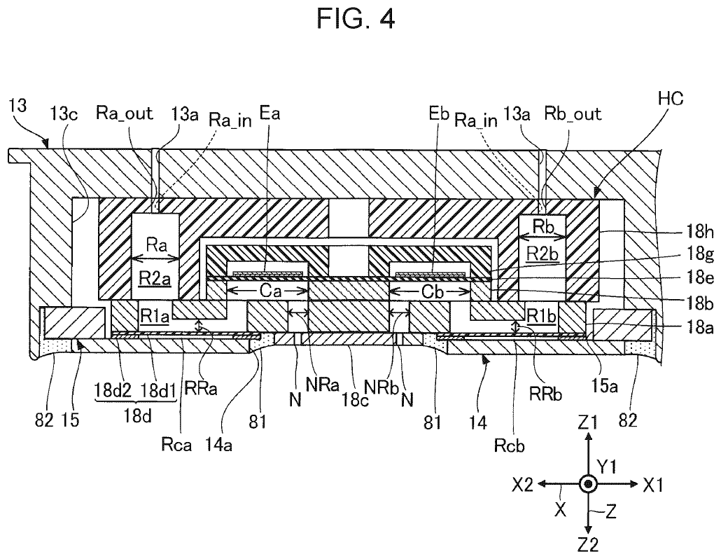

Each head chip HC ejects ink. Each head chip HC is provided with the inlets Ra_in and Rb_in and the outlets Ra_out and Rb_out. Each of the inlets Ra_in and Rb_in is an opening through which ink is introduced. Each of the outlets Ra_out and Rb_out is an opening for discharging ink. Each of the inlets Ra_in and Rb_in and the outlets Ra_out and Rb_out is bonded to the head chip HC and the holder 13 with an adhesive so as to be connected to the corresponding holder flow path 13a in a liquid-tight manner. An example of the configuration of the head chip HC will be described with reference to FIG. 4 described later.

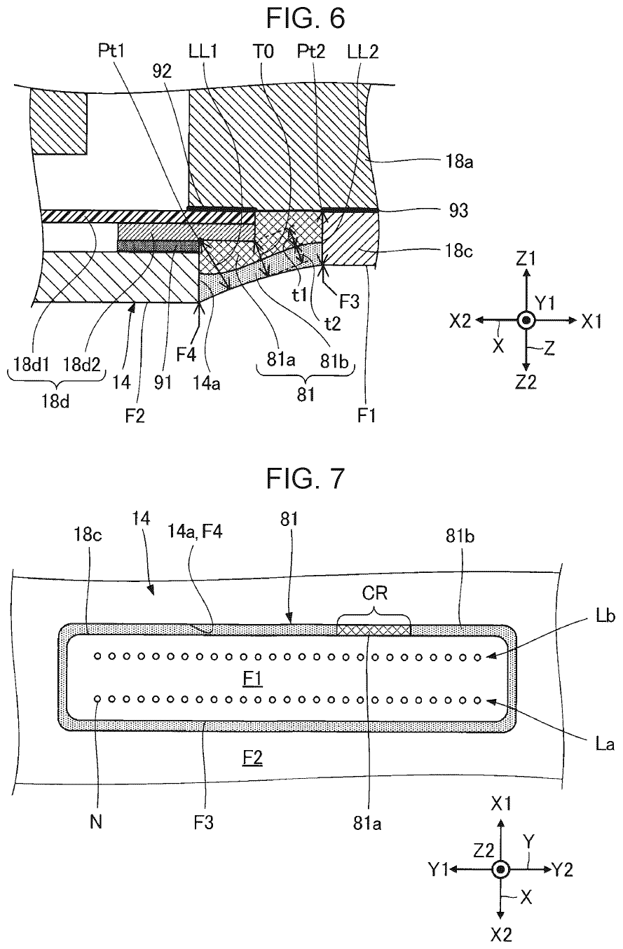

The fixing plate 14 is a plate member for fixing the four head chips HC to the holder 13. Specifically, the fixing plate 14 is disposed in a state where the four head chips HC are held between the fixing plate 14 and the holder 13, and is fixed to the holder 13 with an adhesive. The thickness direction of the fixing plate 14 is parallel to the Z-axis, and as illustrated in FIGS. 6 and 7 described later, the fixing plate 14 has a surface F2 facing the Z2 direction. The surface F2 is an example of a “first surface” or a “second surface” in a case where the sealing material 81 described later is regarded as an example of a “first sealing material”. In addition, the surface F2 is an example of a “first surface” or a “second surface” in a case where the sealing material 82 described later is regarded as an example of a “first sealing material”. The surface F2 is one of a pair of plate surfaces of the fixing plate 14, which faces the outside of the liquid ejecting head 1, and serves as a part of the outer surfaces of the liquid ejecting head 1. The fixing plate 14 is formed of, for example, a metal material or the like. The fixing plate 14 has a plurality of openings 14a for exposing nozzle plates 18c, described later, of the four head chips HC. Therefore, the openings 14a expose the nozzles N described later. In the example illustrated in FIG. 3, each of the plurality of openings 14a is individually provided for each head chip HC. The fixing plate 14 is provided with two through holes 14b for positioning it with respect to the holder 13. The through holes 14b are used as, for example, marks used for alignment when the head chips HC are bonded to the holder 13 one by one.

Although not illustrated in FIG. 3, the gap between an inner peripheral surface F4 of each opening 14a and an outer peripheral surface F3 of the corresponding nozzle plate 18c described later is filled with the sealing material 81 as illustrated in FIGS. 6 and 7 described later. The sealing material 81 is an example of a “first sealing material” in a case where one of the nozzle plate 18c and the fixing plate 14 is regarded as an example of a “first member” and the other is regarded as an example of a “second member”. Further, as illustrated in FIG. 8 described later, the gap between the outer peripheral surface F5 of the fixing plate 14 and the inner peripheral surface F6 of the recesses 13c of the holder 13 is filled with the sealing material 82. The sealing material 82 is an example of a “first sealing material” in a case where one of the fixing plate 14 and the holder 13 is regarded as an example of a “first member” and the other is regarded as an example of a “second member”. Further, the insides of the through holes 14b of the fixing plate 14 are filled with the sealing material 83 as illustrated in FIG. 9 described later. The sealing material 83 is an example of a “first sealing material” in a case where the fixing plate 14 is regarded as an example of a “first member”.

The reinforcing plate 15 is a plate-like member that is disposed between the holder 13 and the fixing plate 14 and reinforces the fixing plate 14. The reinforcing plate 15 is stacked on the fixing plate 14 and is fixed to the fixing plate 14 with an adhesive 95. The reinforcing plate 15 is provided with a plurality of openings 15a in which the four head chips HC are disposed. The reinforcing plate 15 is made of, for example, a metal material. Further, the reinforcing plate 15 is provided with two through holes 15b for positioning the reinforcing plate 15 with respect to the holder 13. These two through holes 15b are provided corresponding to the above-described two through holes 14b, and overlap the two through holes 14b when viewed in the direction along the Z-axis. The reinforcing plate 15 is provided as necessary, and may be omitted.

The cover 16 is a box-shaped member that houses the flow-path member 11a of the flow-path structure 11 and the wiring substrate 12. The cover 16 is made of, for example, a resin material or the like. The cover 16 is provided with four openings 16a and an opening 16b. The four openings 16a correspond to the four flow-path tubes 11b of the flow-path structure 11, and each opening 16a allows insertion of the corresponding flow-path tube 11b. The connector 12a is inserted into the opening 16b from the inside of the cover 16 to the outside.

Here, as illustrated in FIGS. 10 and 11 described later, the cover 16 has a surface F9 that faces a direction intersecting the Z-axis and extending from the inside to the outside of the liquid ejecting head 1. The surface F9 is an example of a “first surface” or a “second surface” in a case where the sealing material 84 described later is regarded as an example of a “first sealing material”. The surface F9 is a part of the outer wall surfaces of the cover and serves as a part of the outer surfaces of the liquid ejecting head 1.

Although not illustrated in FIG. 3, the gap between the cover 16 and the holder 13 is filled with the sealing material 84 described later. The sealing material 84 is an example of a “first sealing material” in a case where one of the cover 16 and the holder 13 is regarded as an example of a “first member” and the other is regarded as an example of a “second member”. Further, the cover 16 has inner peripheral surfaces F11 that define the openings 16a. Each flow-path tube 11b has an outer peripheral surface F10 positioned on the inner inside of the corresponding inner peripheral surface F11 of the cover 16. Then, the space between the inner peripheral surface F11 of each opening 16a and the outer peripheral surface F10 of the corresponding flow-path tube 11b is filled with the sealing material 85 described later. The sealing material 85 is an example of a “first sealing material” in a case where one of the flow-path tube 11b and the cover 16 is regarded as an example of a “first member” and the other is regarded as an example of a “second member”.

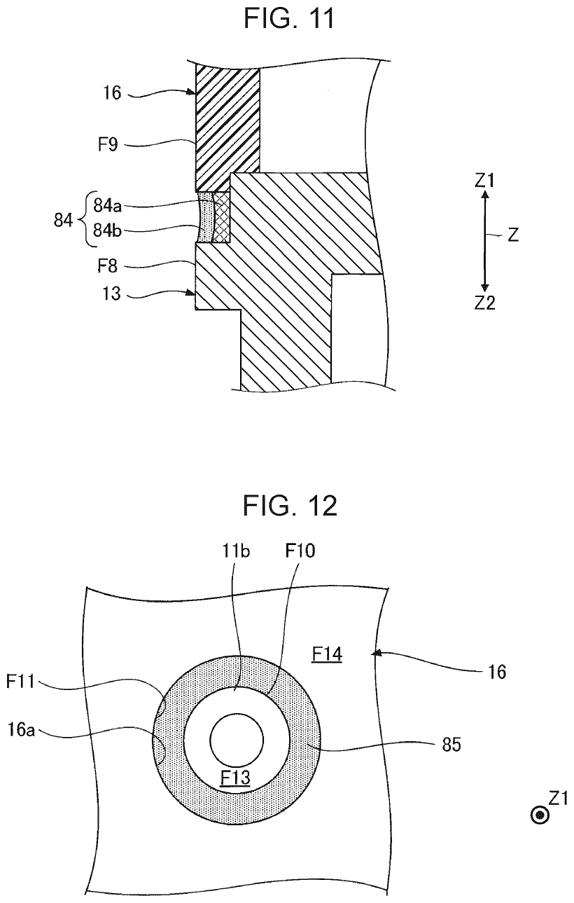

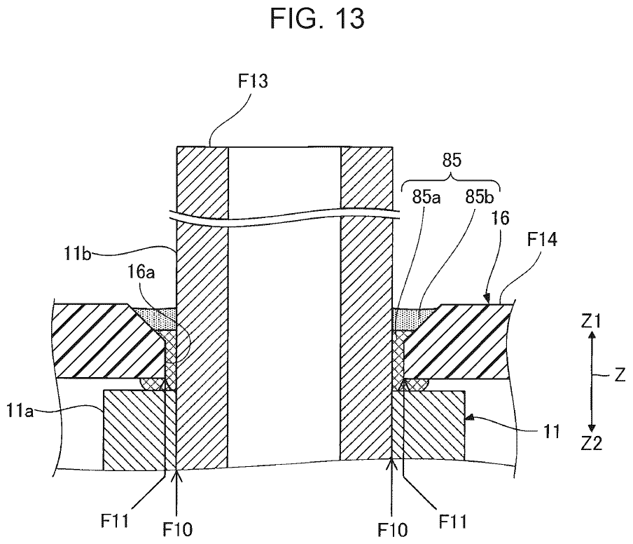

Here, the cover 16 has a surface F14 facing the Z1 direction as illustrated in FIGS. 12 and 13 described later. The surface F14 is an example of a “first surface” or a “second surface” in a case where the sealing material 85 described later is regarded as an example of a “first sealing material”. The surface F14 is a part of the outer wall surfaces of the cover 16 and serves as a part of the outer surfaces of the liquid ejecting head 1. In addition, each flow-path tube 11b has a surface F13 facing the Z1 direction as illustrated in FIGS. 12 and 13 described later. The surface F13 is an example of a “first surface” or a “second surface” in a case where the sealing material 85 described later is regarded as an example of a “first sealing material”.

### 1-3. Head Chip

FIG. 4 illustrates a part of the cross-sectional view taken along line IV-IV in FIG. 3. FIG. 4 shows the head chip HC, the holder 13, the fixing plate 14, and the reinforcing plate 15 in the cross section taken along line IV-IV in FIG. 3. As illustrated in FIG. 4, a plurality of nozzles N for ejecting ink are provided in the head chip HC. The plurality of nozzles N are divided into a nozzle row La and a nozzle row Lb. Each of the nozzle row La and the nozzle row Lb is a set of nozzles N arranged along the Y-axis. The nozzle row La and the nozzle row Lb are spaced from each other in the X-axis direction.

The head chip HC includes a liquid storage chamber Ra, a plurality of pressure chambers Ca, and a plurality of driving elements Ea as components corresponding to the nozzle row La. The liquid storage chamber Ra is a common liquid chamber which is continuous over the plurality of nozzles N of the nozzle row La. One pressure chamber Ca and one driving element Ea are provided for each nozzle N of the nozzle row La. Each pressure chamber Ca is a space communicating with the corresponding nozzle N. Each of the plurality of pressure chambers Ca is filled with ink supplied from the liquid storage chamber Ra. The driving element Ea changes the pressure of the ink in the pressure chamber Ca. The driving element Ea is, for example, a piezoelectric element which changes the capacity of the pressure chamber Ca by deforming a wall surface of the pressure chamber Ca, or a heating element which generates an air bubble in the pressure chamber Ca by heating the ink in the pressure chamber Ca. When the driving element Ea changes the pressure of the ink in the pressure chamber Ca, the ink in the pressure chamber Ca is ejected from the nozzle N.

Here, one inlet Ra in and one outlet Ra_out illustrated in FIG. 3 communicate with the liquid storage chamber Ra. The ink introduced through the inlet Ra_in into the liquid storage chamber Ra is used as appropriate for ejection from each nozzle N of the nozzle row La. The ink that is not ejected from the nozzles N of the nozzle row La and is retained in the liquid storage chamber Ra is discharged from the outlet Ra_out.

In addition, the head chip HC includes a liquid storage chamber Rb, a plurality of pressure chambers Cb, and a plurality of driving elements Eb as components corresponding to the nozzle row Lb. The liquid storage chamber Rb is a common liquid chamber which is continuous over the plurality of nozzles N of the nozzle row Lb. One pressure chamber Cb and one driving element Eb are provided for each nozzle N of the nozzle row Lb. Each of the plurality of pressure chambers Cb is filled with ink supplied from the liquid storage chamber Rb. The driving element Eb is, for example, the piezoelectric element or the heating element described above. When the driving element Eb changes the pressure of the ink in the pressure chamber Cb, the ink in the pressure chamber Cb is ejected from the nozzle N.

Here, one inlet Rb_in and one outlet Rb_out illustrated in FIG. 3 communicate with the liquid storage chamber Rb. The ink introduced through the inlet Rb_in into the liquid storage chamber Rb is used as appropriate for ejection from each nozzle N of the nozzle row Lb. In addition, the ink that is not ejected from the nozzles N of the nozzle row Lb and is retained in the liquid storage chamber Rb is discharged from the outlet Rb_out.

As illustrated in FIG. 4, the head chip HC includes a communication plate 18a, a pressure-chamber substrate 18b, a nozzle plate 18c, a compliance substrate 18d, a diaphragm 18e, the plurality of driving elements Ea and Eb, a cover 18g, and a case 18h. Here, the nozzle plate 18c is an example of a “first member” or a “second member” in a case where the sealing material 81 described later is regarded as a “first sealing material”. Each of the communication plate 18a and the compliance substrate 18d is an example of a “third member” in a case where the sealing material 81 described later is regarded as a “first sealing material”. Further, the reinforcing plate 15 is an example of a “third member” in a case where the sealing material 82 described later is regarded as a “first sealing material”. Note that not only the communication plate 18a, the compliance substrate 18d, and the reinforcing plate 15, but also a member that is not exposed to the outside of the liquid ejecting head 1 among the members constituting the liquid ejecting head 1 may be regarded as a “third member”.

The communication plate 18a and the pressure-chamber substrate 18b are stacked in this order in the Z1 direction, and form flow paths for supplying ink to the plurality of nozzles N. The diaphragm 18e, the plurality of driving elements Ea and Eb, the cover 18g, the case 18h, a wiring substrate 18i, and a driving circuit 18j are provided in a region positioned in the Z1 direction relative to the multilayer body including the communication plate 18a and the pressure-chamber substrate 18b. In a region positioned in the Z2 direction relative to the multilayer body, the nozzle plate 18c and the compliance substrate 18d are provided. Each element of the head chip HC is an approximately plate-like member which is long in the Y direction, and is bonded to one another, for example, with an adhesive or by direct bonding. Hereinafter, each element of the head chip HC will be described in order with reference to FIG. 4.

The nozzle plate 18c is a plate-shaped member which is stacked on the communication plate 18a and includes the plurality of nozzles N of each of the nozzle row La and the nozzle row Lb. Each of the plurality of nozzles N is a through hole through which ink passes and that ejects the ink in the Z2 direction which is the ejection direction. The thickness direction of the nozzle plate 18c is along the Z-axis, and the nozzle plate 18c has a surface F1 facing the Z2 direction as illustrated in FIGS. 6 and 7 described later. The surface F1 is an example of a “first surface” or a “second surface” in a case where the sealing material 81 described later is regarded as an example of a “first sealing material”. The surface F1 is one of a pair of plate surfaces of the nozzle plate 18c, which faces the outside of the liquid ejecting head 1, and is a part of the outer surface of the liquid ejecting head 1. The nozzle plate 18c is manufactured in such a manner that a silicon single crystal substrate is processed by a semiconductor manufacturing technique using a processing technique such as dry etching or wet etching, for example. However, other known methods and materials may be appropriately used for manufacturing the nozzle plate 18c. A cross-sectional shape of the nozzle is typically a circular shape, but is not limited thereto and may be a non-circular shape such as a polygonal shape or an elliptical shape, for example. Here, the nozzle plate 18c is bonded to the surface of the communication plate 18a which faces the Z2 direction with an adhesive (an adhesive layer 93 described later).

In the communication plate 18a, spaces R1a and R1b, a plurality of supply flow paths RRa and RRb, and a plurality of communication flow paths Nra and Nrb are provided for the nozzle row La and the nozzle row Lb, as flow paths communicating with the nozzles N. Each of the spaces R1a and R1b is an elongated opening extending in the direction along the Y-axis in a plan view in the direction along the Z-axis. Each of the supply flow paths RRa and RRb and each of the communication flow paths NRa and NRb are through holes formed for each nozzle N. Each supply flow path RRa communicates with the space R1a. Each supply flow path RRb communicates with the space R1b.

The nozzle plate 18c and the compliance substrate 18d are stacked on the surface of the communication plate 18a facing the Z2 direction, and the foregoing spaces R1a and R1b and the foregoing communication flow paths NRa and NRb are open in the same surface of the communication plate 18a.

The pressure-chamber substrate 18b is a plate-shaped member in which the plurality of pressure chambers Ca and the plurality of pressure chambers Cb are provided. The plurality of pressure chambers Ca are arranged in the direction along the Y-axis. Similarly, the plurality of pressure chambers Cb are arranged in the direction along the Y-axis. Each pressure chamber Ca is formed for each nozzle N of the nozzle row La, and is an elongated space extending in the direction along the X-axis in a plan view. Similarly, each pressure chamber Cb is formed for each nozzle N of the nozzle row Lb, and is an elongated space extending in the direction along the X-axis in a plan view. Similar to the nozzle plate 18c described above, each of the communication plate 18a and the pressure-chamber substrate 18b is manufactured, for example, by processing a silicon single crystal substrate by a semiconductor-manufacturing technique. However, other known methods and materials may be appropriately used for manufacturing each of the communication plate 18a and the pressure-chamber substrate 18b.

The pressure chamber Ca communicates with each of the communication flow path NRa and the supply flow path RRa. Therefore, the pressure chamber Ca communicates with the nozzle N of the nozzle row La via the communication flow path NRa, and communicates with the space R1a via the supply flow path RRa. Similarly, the pressure chamber Cb communicates with each of the communication flow path NRb and the supply flow path RRb. Therefore, the pressure chamber Cb communicates with the nozzle N of the nozzle row Lb via the communication flow path NRb, and communicates with the space R1b via the supply flow path RRb.

The diaphragm 18e is disposed on the surface of the pressure-chamber substrate 18b facing the Z1 direction. The diaphragm 18e is a plate-shaped member that can elastically vibrate. The diaphragm 18e has, for example, a first layer and a second layer, and the first layer and the second layer are stacked together in this order in the Z1 direction. The first layer is, for example, an elastic film made of a silicon oxide (SiO₂). For example, the elastic film is formed by thermally oxidizing one surface of a silicon single crystal substrate. The second layer is, for example, an insulating film made of a zirconium oxide (ZrO₂). The insulating film is formed, for example, by forming a zirconium layer by a sputtering method and then thermally oxidizing the layer. Note that the diaphragm 18e is not limited to the configuration obtained by laminating the first layer and the second layer and, for example, may be configured with a single layer or three or more layers.

The plurality of driving elements Ea and the plurality of driving elements Eb are disposed on the surface of the diaphragm 18e facing the Z1 direction. Each of the driving elements Ea and Eb is a passive element that is deformed by receiving driving signals. Each of the driving elements Ea and Eb has an elongated shape extending in the direction along the X-axis in a plan view. The plurality of driving elements Ea are arranged in the direction along the Y-axis so as to correspond to the plurality of pressure chambers Ca. Each driving element Ea overlaps the corresponding pressure chamber Ca in a plan view. Similarly, the plurality of driving elements Eb are arranged in the direction along the Y-axis so as to correspond to the plurality of pressure chambers Cb. Each driving element Eb overlaps the corresponding pressure chamber Cb in a plan view.

Although not illustrated, each of the driving elements Ea and Eb includes a first electrode, a piezoelectric layer, and a second electrode, which are stacked in this order in the Z1 direction. One electrode of the first electrode and the second electrode is an individual electrode arranged for each driving element Ea or each driving element Eb so as to be spaced from the other individual electrodes, and a driving signal is applied to the one electrode. The other electrode of the first electrode and the second electrode is a strip-shaped common electrode extending in the direction along the Y-axis so as to be continuous over the plurality of driving elements Ea or the plurality of driving elements Eb, and a predetermined reference potential is supplied to the other electrode. Examples of the metal material of these electrodes include metal materials such as platinum (Pt), aluminum (Al), nickel (Ni), gold (Au), and copper (Cu), and among these materials, one kind may be used alone, or two or more kinds may be used in combination in the form of an alloy or a stacking structure. The piezoelectric layer is formed of a piezoelectric material such as lead zirconate titanate (Pb(Zr,Ti)O₃), and has, for example, a strip shape extending in the direction along the Y-axis so as to be continuous over the plurality of driving elements Ea or the plurality of driving elements Eb. However, the piezoelectric layer may be individually provided for each driving element Ea or each driving element Eb. When the diaphragm 18e vibrates in conjunction with the deformation of the driving elements Ea mentioned above, the pressures in the pressure chambers Ca change, and ink is thereby ejected from the nozzles N of the nozzle row La. Similarly, when the diaphragm 18e vibrates in conjunction with the deformation of the driving elements Eb, the pressures in the pressure chambers Cb change, and ink is thereby ejected from the nozzles N of the nozzle row Lb. Note that the driving elements may be heating elements which heat the ink in the pressure chambers Ca and Cb, instead of the driving elements Ea and Eb.

The cover 18g is a plate-shaped member located on the surface of the diaphragm 18e facing the Z1 direction, protects the plurality of driving elements Ea and the plurality of driving elements Eb, and reinforces the mechanical strength of the diaphragm 18e. Here, the plurality of driving elements Ea and the plurality of driving elements Eb are housed between the cover 18g and the diaphragm 18e. For example, the cover 18g is formed of a resin material.

The case 18h is a case for storing ink to be supplied to the plurality of pressure chambers Ca and the plurality of pressure chambers Cb. The case 18h is made of, for example, a resin material. The case 18h is provided with spaces R2a and R2b, the inlets Ra_in and Rb_in, and the outlets Ra_out and Rb_out. The space R2a is a space that communicates with the space R1a described above, and functions, together with the space R1a, as the liquid storage chamber Ra which is a reservoir for storing ink to be supplied to the plurality of pressure chambers Ca. The ink in the liquid storage chamber Ra is supplied to each pressure chamber Ca via the corresponding supply flow path RRa. Similarly, the space R2b is a space that communicates with the space R1b described above, and functions, together with the space R1b, as the liquid storage chamber Rb which is a reservoir for storing ink to be supplied to the plurality of pressure chambers Cb. The ink in the liquid storage chamber Rb is supplied to each pressure chamber Cb via the corresponding supply flow path RRb.

The compliance substrate 18d is a substrate that absorbs fluctuations in the pressures of the inks in the liquid storage chambers Ra and Rb. The compliance substrate 18d is stacked on the communication plate 18a at positions different from the nozzle plate 18c. That is, the compliance substrate 18d and the nozzle plate 18c are stacked on the surface of the communication plate 18a facing the Z2 direction so as not to overlap each other.

The compliance substrate 18d includes a compliance film 18d1 and a frame 18d2. The compliance film 18d1 is a flexible resin film that serves as the wall surfaces of the liquid storage chambers Ra and Rb. The surface of the compliance film 18d1 facing the Z1 direction is bonded to the communication plate 18a with an adhesive (an adhesive layer 92 described later) such as an epoxy-based adhesive. The frame 18d2 is bonded to the surface of the compliance film 18d1 facing the Z2 direction with an adhesive such as a urethane-based adhesive or an epoxy-based adhesive. The frame 18d2 is a frame-shaped member for forming compliance spaces Rca and Rcb. The frame 18d2 is made of, for example, a metal material such as stainless steel, aluminum, titanium, and a magnesium alloy. The compliance substrate 18d may be a thin metal plate having flexibility.

The surface of the frame 18d2 facing the Z2 direction is bonded to the above-described fixing plate 14 with an adhesive (an adhesive layer 91 described later) such as an epoxy-based adhesive. Here, the compliance spaces Rca and Rcb partitioned by the frame 18d2 are formed between the compliance film 18d1 and the fixing plate 14. The compliance space Rca is a space that is separated from the liquid storage chamber Ra by the compliance film 18d1 and allows the compliance film 18d1 to be deformed according to changes in the pressure of the ink in the liquid storage chamber Ra. The compliance space Rcb is a space that is separated from the liquid storage chamber Rb by the compliance film 18d1 and allows the compliance film 18d1 to be deformed according to changes in the pressure of the ink in the liquid storage chamber Rb.

In addition, although not illustrated, a wiring substrate for electrically coupling the control unit 20 and the head chip HC is mounted on the surface of the diaphragm 18e facing the Z1 direction. The wiring substrate is, for example, a substrate such as a chip on film (COF), a flexible printed circuit (FPC), or a flexible flat cable (FFC), and a drive circuit for supplying a drive voltage to each of the driving elements Ea and Eb is mounted on the wiring substrate. The drive circuit is a circuit that switches, based on the control signal S, whether or not to supply at least a part of the waveform included in the drive signal D as a drive pulse.

As described above, each head chip HC described above is fixed to the holder 13 by using the fixing plate 14 with the reinforcing plate 15 interposed therebetween in a state of being housed in one of the recesses 13c of the holder 13. Here, the fixing plate 14 has an inner peripheral surface F4 defining the openings 14a as illustrated in FIG. 6 described later. Each nozzle plate 18c has an outer peripheral surface F3 positioned on the inner side of the inner peripheral surface F4 as illustrated in FIG. 6 described later. The sealing material 81 is disposed in the gaps between the outer peripheral surfaces F3 of the nozzle plates 18c and the inner peripheral surfaces F4 of the openings 14a. The sealing material 81 is an example of a “first sealing material” in a case where one of the nozzle plate 18c and the fixing plate 14 is regarded as an example of a “first member” and the other is regarded as an example of a “second member”.

In addition, the fixing plate 14 is disposed in the recesses 13c in a state of being stacked together with the reinforcing plate 15. That is, as illustrated in FIG. 8 described later, the outer peripheral surface F5 is disposed on the inner side of the inner peripheral surface F6 of the recesses 13c. The sealing material 82 is disposed in the gap between the outer peripheral surface F5 of the fixing plate 14 and the inner peripheral surface F6 of the recesses 13c. The sealing material 82 is an example of a “first sealing material” in a case where one of the fixing plate 14 and the holder 13 is regarded as an example of a “first member” and the other is regarded as an example of a “second member”.

FIG. 5 is a bottom view of the liquid ejecting head 1 according to the embodiment. FIG. 5 illustrates the liquid ejecting head 1 viewed in the Z1 direction. As illustrated in FIG. 5, the sealing material 81 is provided over the entire periphery of the outer peripheral surface F3 of each nozzle plate 18c or the inner peripheral surface F4 of each opening 14a. Details of the sealing material 81 will be described later with reference to FIGS. 6 and 7.

In addition, the sealing material 82 is provided over the entire periphery of the outer peripheral surface F5 of the fixing plate 14 or the inner peripheral surface F6 of the recesses 13c. Details of the sealing material 82 will be described later with reference to FIG. 8.

The through holes 14b of the fixing plate 14 are filled with the sealing material 83. Details of the sealing material 83 will be described later with reference to FIG. 9.

1-4. Sealing between Fixing Plate and Nozzle Plates

FIG. 6 is an explanatory view of the sealing material 81 disposed between a nozzle plate 18c and the fixing plate 14. FIG. 7 is an explanatory view of the sealing material 81 in FIG. 6, illustrating its effect. FIG. 7 illustrates a view of the sealing material 81 when viewed in the Z1 direction in a state where a second layer 81b described later is partially detached.

As described above, the sealing material 81 is disposed between the outer peripheral surface F3 of each nozzle plate 18c and the inner peripheral surface F4 of the corresponding opening 14a. Here, as described above, the liquid ejecting head 1 includes the compliance substrate 18d and the communication plate 18a, and each of the compliance substrate 18d and the communication plate 18a does not serve as an outer surface of the liquid ejecting head 1. In contrast, the nozzle plates 18c and the fixing plate 14 serve as outer surfaces of the liquid ejecting head 1. The sealing material 81 is composed of an adhesive such as an epoxy-based adhesive.

The compliance substrate 18d and the fixing plate 14 are bonded to each other via the adhesive layer 91. The compliance substrate 18d and the communication plate 18a are bonded to each other via the adhesive layer 92. The communication plate 18a and the nozzle plate 18c are bonded to each other via the adhesive layer 93. Each of the adhesive layers 91, 92, and 93 is a layer composed of an adhesive such as an epoxy-based adhesive or a silicone-based adhesive, and is not exposed to the outside of the liquid ejecting head 1. Here, the adhesive layer 91 is an example of a “second sealing material”, and is disposed in the gap between the compliance substrate 18d and the fixing plate 14. The adhesive layer 92 is an example of a “second sealing material” and is disposed in the gap between the compliance substrate 18d and the communication plate 18a. The adhesive layer 93 is an example of a “second sealing material” and is disposed in the gap between the communication plate 18a and the nozzle plate 18c. As described above, the liquid ejecting head 1 includes the adhesive layers 91, 92, and 93.

Since the sealing material 81 is particularly close to nozzles N, the sealing material 81 easily swells or dissolves due to the adhesion of ink mist. In addition, in a case where the wiping member 70 is used as in the present embodiment, the sealing material 81 comes into contact with ink also at the time of cleaning or wiping by the wiping member 70, and thus the sealing material 81 easily swells or dissolves also in this point. In addition, a surface of the sealing material 81 is sometimes scraped due to contact with the wiping member 70. In this case, if the adhesive layer 91 between the fixing plate 14 and the compliance substrate 18d is exposed to the outside, the adhesive layer 91 may swell or dissolve due to contact with ink, thereby causing an adhesion failure. When the adhesion failure occurs, the compliance substrate 18d cannot serve its role, which can adversely affect the ejection of ink. Further, in this case, if the adhesive layers 92 and 93 are exposed to the outside, the adhesive layers 92 and 93 may also suffer adhesion failure due to swelling or dissolution caused by contact with ink, which can adversely affect the ejection of ink. Hence, it is required that whether the sealing material 81 has reached a state in which a sealing failure is likely to occur can be detected before such a problem occurs.

Therefore, the sealing material 81 has a first layer 81a and the second layer 81b. These layers are stacked in the order of the first layer 81a and the second layer 81b from the inside to the outside of the liquid ejecting head 1.

Here, the first layer 81a is covered with the second layer 81b, and thus is not exposed to the outside of the liquid ejecting head 1. In contrast, the second layer 81b is exposed to the outside of the liquid ejecting head 1. The color of the first layer 81a and the color of the second layer 81b are different from each other.

Since the first layer 81a is covered with the second layer 81b, and the second layer 81b is exposed to the outside of the liquid ejecting head 1, in a case where the sealing material 81 is partially detached due to swelling or dissolution caused by contact with ink or receiving an external force, the second layer 81b is partially detached earlier than the first layer 81a. When at least a part of the second layer 81b in the peripheral direction is detached over the entire thickness thereof, the first layer 81a is exposed at a portion CR, which is the partially detached portion, as illustrated in FIG. 7. In this case, since the color of the first layer 81a and the color of the second layer 81b are different from each other, it is possible to detect that the second layer 81b is partially detached at the portion CR which is the exposed portion of the first layer 81a. Therefore, before a problem occurs in the liquid ejecting head 1 due to peeling of the first layer 81a caused by swelling, dissolution, scraping, or the like of the first layer 81a, it is possible to detect a state in which the first layer 81a is soon scraped, dissolved, or partially detached. Hereinafter, “a state in which the first layer 81a is soon scraped, dissolved, or partially detached” is referred to as “a near-failure state of the first layer 81a”.

Here, the expression that “the colors are different” means that a difference in at least one of hue, brightness, and saturation can be visually recognized in a state where the liquid ejecting head 1 is irradiated with visible light or ultraviolet light.

To be more specific, the color difference between the color of the first layer 81a and the color of the second layer 81b is preferably 12.0 or more, more preferably 25 or more. Accordingly, it is possible to easily visually recognize the difference between the color of the first layer 81a and the color of the second layer 81b. The color difference mentioned above is, for example, based on the CIE 1976 L*a*B* color space. The measurement of the color difference is performed in accordance with JIS Z8730, for example.

The colors of the first layer 81a and the second layer 81b may be chromatic colors or may be achromatic colors. Chromatic colors refer to the colors having all of hue, saturation, and brightness. Specific examples of chromatic colors are not particularly limited and include, for example, JIS safety colors (red, yellowish red, yellow, green, blue, and reddish purple). Achromatic colors refer to the colors that lack both hue and saturation. Specific examples of achromatic colors are not particularly limited and include, for example, contrasting colors (white and black) of JIS safety colors.

However, when the color of one of the first layer 81a and the second layer 81b is a chromatic color and the color of the other is an achromatic color, the chromatic color is conspicuous while the achromatic color is inconspicuous, and thus the color of the first layer 81a and the color of the second layer 81b are easily distinguished from each other. The color of the first layer 81a is preferably a chromatic color and the color of the second layer 81b is preferably an achromatic color from the viewpoint that it is easy to detect that the first layer is exposed when the color of the portion CR which is the exposed portion of the first layer 81a is more conspicuous than the color of the portion where the first layer 81a is not exposed and the second layer 81b is exposed.

Each of the first layer 81a and the second layer 81b is made of, for example, a resin composition containing a thermosetting resin such as an epoxy resin. However, the composition of the resin composition forming the first layer 81a and the composition of the resin composition forming the second layer 81b are different from each other so that the color of the first layer 81a and the color of the second layer 81b are different from each other. The resin composition may contain inorganic fillers such as silica or alumina, or may contain other additives.

One or both of the resin composition forming the first layer 81a and the resin composition forming the second layer 81b contain a coloring agent, if necessary. In the case where at least one of the first layer 81a and the second layer 81b contains a coloring agent, the degree of difference between the color of the first layer 81a and the color of the second layer 81b can be easily adjusted by changing the type, content, and the like of the coloring agent.

The coloring agent is not particularly limited, and examples thereof include various pigments and various dyes.

Examples of pigments include C.I. Pigment Red 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, and 108:1; C.I. Pigment Green 7, 36, 15, 17, 18, 19, 26, and 50; C.I. Pigment Blue 1, 15, 15:1, 15:2, 15:3, 15:4, 15:6, 17:1, 18, 60, 27, 28, 29, 35, 36, and 80; C.I. Pigment Yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157; C.I. Pigment Violet 1, 3, 19, 23, 50, 14, and 16; C.I. Pigment Orange 5, 13, 16, 36, 43, 20, 20:1, and 104; and C.I. Pigment Brown 25, 7, 11, and 33. These pigments can be used alone or in combination of two or more thereof.

Examples of the dyes include azo dye; anthraquinone dye; condensed polycyclic aromatic carbonyl dyes; indigoid dye; carbonium dye; phthalocyanine dye, methine, and polymethine dyes. Specific examples of dyes include C.I. Direct Red 2, 4, 9, 23, 26, 28, 31, 39, 62, 63, 72, 75, 76, 79, 80, 81, 83, 84, 89, 92, 95, 111, 173, 184, 207, 211, 2 12, 214, 218, 221, 223, 224, 225, 226, 227, 232, 233, 240, 241, 242, 243, and 247; C.I. Acid Red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C. I. Reactive Red 3, 13, 17, 19, 21, 22, 23, 24, 29, 35, 37, 40, 41, 43, 45, 49, and 55; C. I. Basic Red 12, 13, 14, 15, 18, 22, 23, 24, 25, 27, 29, 35, 36, 38, 39, 45, and 46; C. I. Direct Violet 7, 9, 47, 48, 51, 66, 90, 93, 94, 95, 98, 100, and 101; C. I. Acid Violet 5, 9, 11, 34, 43, 47, 48, 51, 75, 90, 103, and 126; C. I. Reactive Violet 1, 3, 4, 5, 6, 7, 8, 9, 16, 17, 22, 23, 24, 26, 27, 33, and 34; C. I. Basic Violet 1, 2, 3, 7, 10, 15, 16, 20, 21, 25, 27, 28, 35, 37, 39, 40, and 48; C. I. Direct Yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C. I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C. I. Reactive Yellow 2, 3, 13, 14, 15, 17, 18, 23, 24, 25, 26, 27, 29, 35, 37, 41, and 42; C. I. Basic Yellow 1, 2, 4, 11, 13, 14, 15, 19, 21, 23, 24, 25, 28, 29, 32, 36, 39, and 40; C. I. Acid Green 16; C. I. Acid Blue 9, 45, 80, 83, 90, and 185; and C. I. Basic Orange 21 and 23. These dyes can be used alone or in combination of two or more thereof.

The content of the coloring agent in the first layer 81a or the second layer 81b is not particularly limited unless the sealing material 81 is insufficiently cured.

In a case where both the first layer 81a and the second layer 81b contain a coloring agent, the color of the coloring agent contained in the first layer 81a and the color of the coloring agent contained in the second layer 81b are preferably different from each other. Thereby, the color of the first layer 81a and the color of the second layer 81b can be different from each other. In this case, the second layer 81b may be colored and semi-transparent. Being colored and semi-transparent is a state in which the second layer 81b is colored but the first layer 81a can be seen through it. However, the second layer 81b is preferably opaque from the viewpoint of making it easy to recognize a partially detached portion of the second layer 81b.

In a case where the second layer 81b does not contain a coloring agent and the first layer 81a contains a coloring agent, the second layer 81b is preferably opaque from the viewpoint of making it easy to recognize a partially detached portion of the second layer 81b.

In a case where the first layer 81a does not contain a coloring agent and the second layer 81b contains a coloring agent, the second layer 81b may be colored and semi-transparent, but is preferably opaque from the viewpoint of making it easy to recognize a partially detached portion of the second layer 81b.

In a case where neither the first layer 81a nor the second layer 81b contains a coloring agent, it is preferable that the type of the sealing material forming the first layer 81a and the type of the sealing material forming the second layer 81b are different from each other. Thereby, the color of the first layer 81a and the color of the second layer 81b can be different from each other. In addition, in this case, the second layer 81b is preferably opaque from the viewpoint of making it easy to recognize a partially detached portion of the second layer 81b.

When each of the first layer 81a and the second layer 81b contains a coloring agent, the color of the coloring agent contained in the first layer 81a and the color of the coloring agent contained in the second layer 81b are preferably different from each other. This makes it possible to easily adjust the difference between the color of the first layer 81a and the color of the second layer 81b by changing the types, the content, or the like of the coloring agents used in the first layer 81a and the second layer 81b.

The components of the first layer 81a excluding the coloring agent and the components of the second layer 81b excluding the coloring agent are preferably the same as each other. For example, the resin component included in the first layer 81a and the resin component included in the second layer 81b are preferably the same, and in the case of using fillers, the type and content of the fillers contained in the first layer 81a and the type and content of the fillers contained in the second layer 81b are preferably the same. Thereby, the difference in the coefficient of linear expansion between the first layer 81a and the second layer 81b can be substantially eliminated. Therefore, it is possible to reduce peeling of the sealing material 81 due to the difference in the coefficient of linear expansion. As the difference in the coefficient of linear expansion increases, the difference in the amount of shrinkage between the first layer 81a and the second layer 81b along with curing also increases. Therefore, the sealing material 81 is warped due to the difference between the stresses of the first layer 81a and the second layer 81b, and thus the sealing material 81 is easily peeled.

The coloring agent is preferably a dye. Since the particles of dyes are smaller than the particles of pigments, the adverse effect of the particles of the coloring agent can be reduced as compared with the case where a pigment is used. Examples of the adverse effects include damage to the wiping member 70 due to adhesion of particles of the coloring agent, damage to nozzle plates 18c due to particles of the coloring agent interposed between the wiping member 70 and the nozzle plates 18c, and ejection failures due to the particles of the coloring agent being retained in nozzles N. The coloring agent is not limited to a dye and may be a pigment.

In a case where at least one of the first layer 81a and the second layer 81b contains, as a coloring agent, a fluorescent material that emits light when irradiated with ultraviolet light, one or both of the first layer 81a and the second layer 81b can be made to emit light by irradiating the sealing material 81 with ultraviolet light. In this state, the difference between the color of the first layer 81a and the color of the second layer 81b can be recognized based on the presence or absence of light emission or the difference in emission color between the first layer 81a and the second layer 81b.

Examples of the fluorescent material include fluorescent pigments or fluorescent dyes, specifically, C. I. Disperse Red 364, C. I. Disperse Red 362, C. I. Vat Red 41, C. I. Disperse Yellow 232, C. I. Disperse Yellow 184, C. I. Disperse Yellow 82, and C.I. Disperse Yellow 43.

The first layer 81a is disposed between the surface F1 of each nozzle plate 18c and the surface F2 of the fixing plate 14 when viewed in the Z1 direction opposite to the Z2 direction which is an example of the “first direction”. Accordingly, as illustrated in FIG. 7, since the first layer 81a is located at a visible position when viewed in the direction opposite to the Z2 direction, it is possible to easily detect the near-failure state of the first layer 81a.

Similarly, when viewed in the direction opposite to the Z2 direction, the second layer 81b is also disposed between the surface F1 and the surface F2. Accordingly, it is possible to visually recognize the exposed portion of the first layer 81a due to a partially detached portion of the second layer 81b when viewed in the direction opposite to the Z2 direction.

The first layer 81a is disposed between the outer peripheral surface F3 and the inner peripheral surface F4. Accordingly, since the first layer 81a is located at a visible position when viewed in the Z1 direction which is the direction along the central axis of the opening 14a of the fixing plate 14, the near-failure state of the first layer 81a can be easily detected.

Similarly, the second layer 81b is also disposed between the outer peripheral surface F3 and the inner peripheral surface F4. Accordingly, it is possible to visually recognize the portion CR which is the exposed portion of the first layer 81a due to partial detachment of the second layer 81b when viewed in the Z1 direction which is the direction along the central axis of the opening 14a of the fixing plate 14.

The first layer 81a is in contact with the adhesive layer 91 provided between the fixing plate 14 and the compliance substrate 18d. Accordingly, even when the second layer 81b is peeled, the adhesive layer 91 is still covered with the first layer 81a, and thus it is possible to detect that the second layer 81b has been partially detached before the adhesive layer 91 is exposed to the outside. For this reason, it is possible to prevent a problem such as an ejection failure which is caused by peeling of the adhesive layer 91 due to adhesion of ink.

Similarly, the first layer 81a is in contact with the adhesive layer 93 provided between the nozzle plate 18c and the communication plate 18a. Accordingly, even when the second layer 81b is peeled, the adhesive layer 93 is still covered with the first layer 81a, and thus it is possible to detect that the second layer 81b has been partially detached before the adhesive layer 93 is exposed to the outside. Therefore, it is possible to prevent a problem such as an ejection failure caused by partial detachment of the adhesive layer 93 due to adhesion of ink.

The thickness t1 of the first layer 81a at the position T0 where the width of the sealing material 81 is the smallest is preferably larger than the thickness t2 of the second layer 81b at the position TO. Accordingly, when the sealing material 81 is scraped from the surface where the second layer 81b is exposed to the outside to the boundary between the second layer 81b and the first layer 81a at the position T0 where the sealing material 81 is thinnest, half or more of the entire thickness of the sealing material 81 remains. For this reason, before a problem due to peeling of the first layer 81a occurs, it is possible to detect the possibility of occurrence of the problem at an early stage.

The thickness of the sealing material 81 is the distance from one surface of the first layer 81a that is not the boundary surface between the first layer 81 a and the second layer 81b and is not in contact with either the nozzle plate 18c or the fixing plate 14 to the surface of the second layer 81b that is exposed to the outside.

When the shortest line segment LL1 is drawn from the position Pt1 where the adhesive layer 91 and the first layer 81a are in contact with each other between the compliance substrate 18d and the fixing plate 14 to the surface of the second layer 81b that is exposed to the outside, the length of the portion of the line segment LL1 passing through the first layer 81a is preferably greater than the length of the portion of the line segment LL1 passing through the second layer 81b. Thus, before the adhesive layer 91 is exposed due to peeling of the first layer 81a covering the adhesive layer 91, it is possible to detect that the adhesive layer 91 will be exposed soon.

When the shortest line segment LL2 is drawn from the position Pt2 where the adhesive layer 93 and the first layer 81a are in contact with each other between the communication plate 18a and the nozzle plate 18c to the surface of the second layer 81b exposed to the outside, the length of the portion of the line segment LL2 passing through the first layer 81a is preferably greater than the length of the portion of the line segment LL2 passing through the second layer 81b. Thus, before the adhesive layer 93 is exposed due to peeling of the first layer 81a covering the adhesive layer 93, it is possible to detect that the adhesive layer 93 will be exposed soon.

The thickness t1 of the first layer 81a at the position T0 is preferably not less than twice the thickness t2 of the second layer 81b at the position TO, more preferably not less than twice and not more than three times the thickness t2 of the second layer 81b. Accordingly, before a problem due to peeling of the first layer 81a occurs, it is possible to detect the possibility of occurrence of the problem at an early and appropriate time. The thickness t1 of the first layer 81a may be not less than three times the thickness t2 of the second layer 81b. The length of the portion of the line segment LL1 passing through the first layer 81a is preferably not less than twice the length of the portion of the line segment LL1 passing through the second layer 81b, more preferably not less than twice and not more than three times the length of the portion of the line segment LL1 passing through the second layer 81b. Furthermore, the length of the portion of the line segment LL2 passing through the first layer 81a is preferably not less than twice the length of the portion of the line segment LL2 passing through the second layer 81b, more preferably not less than twice and not more than three times the length of the portion of the line segment LL2 passing through the second layer 81b. Also with this setting, before a problem due to peeling of the first layer 81a occurs, it is possible to detect the possibility of the occurrence of the problem at an early and appropriate time.

As described above, the sealing material 81 includes the first layer 81a and the second layer 81b. In contrast, each of the adhesive layers 91, 92, and 93 is formed of only one layer. Hence, even if the adhesive layers 91, 92, and 93 which are not exposed to the outside have a two-layer structure with different colors, it is not easy to visually inspect the adhesive layers 91, 92, and 93. Therefore, by forming each of the adhesive layers 91, 92, and 93 with only one layer, it is possible to reduce the cost necessary for the adhesive layers 91, 92, and 93. In the present embodiment, the “second sealing material” is not limited to the adhesive layers 91, 92, and 93. Examples of other applicable portions of the “second sealing material” include the portions between the driving elements Ea and Eb and the diaphragm 18e, which are not illustrated, the portion between the diaphragm 18e and the wiring substrate mounted on the surface of the diaphragm 18e facing the Z1 direction, which is not illustrated, and the like.

1-5. Sealing between Fixing plate and Holder

FIG. 8 is an explanatory view of the sealing material 82 disposed between the holder 13 and the fixing plate 14. The sealing material 82 is disposed between the outer peripheral surface F5 of the fixing plate 14 and the inner peripheral surface F6 of the recesses 13c of the holder 13. Here, as described above, the liquid ejecting head 1 includes the reinforcing plate 15, and the reinforcing plate 15 does not serve as an outer surface of the liquid ejecting head 1. In contrast, the fixing plate 14 and the holder 13 serve as outer surfaces of the liquid ejecting head 1. The sealing material 82 is composed of an adhesive such as an epoxy-based adhesive.

In addition, a stepped surface 13cl facing the Z2 direction is provided at the inner peripheral surface F6 of the recesses 13c, and the surface of the reinforcing plate 15 facing the Z1 direction is bonded to the stepped surface 13cl via an adhesive layer 94. In addition, the surface of the reinforcing plate 15 facing the Z2 direction is bonded via an adhesive layer 95 to the surface of the fixing plate 14 facing the Z1 direction. Each of the adhesive layers 94 and 95 is a layer composed of an adhesive such as an epoxy-based adhesive or a silicone-based adhesive, and is not exposed to the outside of the liquid ejecting head 1.

Since the sealing material 82, similar to the sealing material 81, is particularly close to nozzles N, the sealing material 82 easily swells or dissolves due to adhesion of ink mist. In addition, in a case where the wiping member 70 is used as in the present embodiment, since the sealing material 82 comes into contact with ink also at the time of cleaning or wiping by the wiping member 70, the sealing material 82 easily swells or dissolves also in this point. Further, a surface of the sealing material 82 can be scraped by coming into contact with the wiping member 70 in some cases. If the sealing material 82 is scraped and the adhesive layer 94 or the adhesive layer 95 is exposed to the outside, the adhesive layer 94 or the adhesive layer 95 can swell or dissolve due to contact with ink and cause an adhesion failure, which can cause a problem that the fixing plate 14 or the reinforcing plate 15 peels.

Therefore, the sealing material 82 has a first layer 82a and a second layer 82b. These layers are stacked in the order of the first layer 82a and the second layer 82b from the inside to the outside of the liquid ejecting head 1.

Here, the first layer 82a is covered with the second layer 82b, and thus is not exposed to the outside of the liquid ejecting head 1. In contrast, the second layer 82b is exposed to the outside of the liquid ejecting head 1. The color of the first layer 82a and the color of the second layer 82b are different from each other. The constituent materials and the magnitude relationship of the thicknesses of the first layer 82a and the second layer 82b are the same as those of the first layer 81a and the second layer 81b of the sealing material 81 described above.

In this manner, since the first layer 82a is covered with the second layer 82b, and the second layer 82b is exposed to the outside of the liquid ejecting head 1, in a case where the sealing material 82 is partially detached due to swelling or dissolution caused by contact with ink or receiving an external force, the second layer 82b is partially detached earlier than the first layer 82a. When the second layer 82b is partially detached over the entire thickness thereof, the first layer 82a is exposed at the partially detached portion. In this state, since the color of the first layer 82a and the color of the second layer 82b are different from each other, it is possible to detect that the second layer 82b has been partially detached at the exposed portion of the first layer 82a. Therefore, before a problem occurs due to peeling of the first layer 82a caused by swelling, dissolving, scraping, or the like of the first layer 82a, it is possible to detect the possibility of occurrence of a problem due to the first layer 81a being soon scraped, dissolved, or partially detached. That is, the near-failure state of the first layer 82a can be detected.

The first layer 82a is disposed between the surface F2 of the fixing plate 14 and the surface F12 of the holder 13 when viewed in the Z1 direction opposite to the Z2 direction which is an example of the “first direction”. Hence, as illustrated in FIG. 5, since the first layer 82a is located at a visible position when viewed in the direction opposite to the Z2 direction, the near-failure state of the first layer 82a can be easily detected.

Similarly, the second layer 82b is also disposed between the surface F2 and the surface F12 when viewed in the direction opposite to the Z2 direction. Accordingly, it is possible to visually recognize an exposed portion of the first layer 82a due to partial detachment of the second layer 82b when viewed in the direction opposite to the Z2 direction.

Further, the first layer 82a is disposed between the outer peripheral surface F5 and the inner peripheral surface F6. Since the first layer 82a is located at a visible position when viewed in the Z1 direction, the near-failure state of the first layer 82a can be easily detected.

Similarly, the second layer 82b is also disposed between the outer peripheral surface F5 and the inner peripheral surface F6. Accordingly, it is possible to visually recognize an exposed portion of the first layer 82a due to partial detachment of the second layer 82b when viewed in the Z1 direction.

The first layer 82a is in contact with the adhesive layer 95 provided between the reinforcing plate 15 and the fixing plate 14. Accordingly, even when the second layer 82b is peeled, the adhesive layer 95 is still covered with the first layer 82a, and thus it is possible to detect that the second layer 82b has been peeled before the adhesive layer 95 is exposed to the outside. Therefore, it is possible to prevent a problem such as an ejection failure caused by peeling of the adhesive layer 95 due to adhesion of ink.

### 1-6. Sealing of Through Holes of Fixing Plate

FIG. 9 is an explanatory view of the sealing material 83 disposed in a through hole 14b of the fixing plate 14 and a through hole 15b of the reinforcing plate 15. The through holes 14b and the through holes 15b are connected so as to be continuous, and the through holes formed by these through holes are filled with the sealing material 83. Here, the surface F2 of the fixing plate 14 facing the Z2 direction serves as an outer surface of the liquid ejecting head 1. The sealing material 83 is composed of an adhesive such as an epoxy-based adhesive.

Since the sealing material 83, similar to the sealing material 81 and the sealing material 82, is close to nozzles N, the sealing material 83 easily swells or dissolves due to adhesion of ink mist. In addition, in a case where the wiping member 70 is used as in the present embodiment, since the sealing material 83 comes into contact with ink also at the time of cleaning or wiping by the wiping member 70, the sealing material 82 easily swells or dissolves also in this respect. Further, the surface of the sealing material 83 can be scraped by coming into contact with the wiping member 70 in some cases. If the sealing material 83 is scraped and the adhesive layer 94 disposed between the holder 13 and the reinforcing plate 15 is exposed to the outside, the adhesive layer 94 can swell or dissolve due to contact with ink and cause an adhesion failure, and this can cause a problem such as peeling of the reinforcing plate 15 in the end.

The sealing material 83 includes a first layer 83a and a second layer 83b. These layers are stacked in the order of the first layer 83a and the second layer 83b from the inside to the outside of the liquid ejecting head 1.

Here, the first layer 83a is covered with the second layer 83b, and thus is not exposed to the outside of the liquid ejecting head 1. In contrast, the second layer 83b is exposed to the outside of the liquid ejecting head 1. The color of the first layer 83a and the color of the second layer 83b are different from each other. The constituent materials and the magnitude relationship of the thicknesses of the first layer 83a and the second layer 83b are the same as those of the first layer 81a and the second layer 81b of the sealing material 81 described above.

In this manner, since the first layer 83a is covered with the second layer 83b, and the second layer 83b is exposed to the outside of the liquid ejecting head 1, in a case where the sealing material 83 is partially detached due to swelling or dissolution caused by contact with ink or receiving an external force, the second layer 83b is partially detached earlier than the first layer 83a. When the second layer 83b is partially detached over the entire thickness thereof, the first layer 83a is exposed at the partially detached portion. In this state, since the color of the first layer 83a and the color of the second layer 83b are different from each other, it is possible to detect that the second layer 83b has been partially detached at the exposed portion of the first layer 83a. Therefore, before a problem occurs due to peeling of the first layer 83a caused by swelling, dissolution, scraping, or the like of the first layer 83a, it is possible to detect the possibility of occurrence of a problem due to the first layer 81a being soon scraped, dissolved, or partially detached. That is, the near-failure state of the first layer 83a can be detected.

1-7. Sealing between Holder and Cover

FIG. 10 is a side view of the liquid ejecting head 1 according to the embodiment. FIG. 11 is an explanatory view of the sealing material 84 disposed between the cover 16 and the holder 13. The sealing material 84 is disposed in the gap between the surface F9 which is an outer peripheral surface of the cover 16 and the surface F8 which is an outer peripheral surface of the holder 13 when viewed in a direction intersecting the Z-axis. The sealing material 84 is composed of an adhesive such as an epoxy-based adhesive or a silicone-based adhesive.

When the sealing material 84 swells due to ink mist, dissolves, and is lost, an adhesion failure occurs between the holder 13 and the cover 16. Thus, ink can adhere to electronic components such as a circuit board, for example, the wiring substrate 12, inside the cover 16, causing a failure.

Therefore, the sealing material 84 has a first layer 84a and a second layer 84b. These layers are stacked in the order of the first layer 84a and the second layer 84b from the inside to the outside of the liquid ejecting head 1 in the direction intersecting the Z-axis.

Here, the first layer 84a is covered with the second layer 84b, and thus is not exposed to the outside of the liquid ejecting head 1. In contrast, the second layer 84b is exposed to the outside of the liquid ejecting head 1. The color of the first layer 84a and the color of the second layer 84b are different from each other. The constituent materials and the magnitude relationship of the thicknesses of the first layer 84a and the second layer 84b are the same as those of the first layer 81a and the second layer 81b of the sealing material 81 described above.

In this manner, since the first layer 84a is covered with the second layer 84b, and the second layer 84b is exposed to the outside of the liquid ejecting head 1, in a case where the sealing material 84 is partially detached due to swelling or dissolution caused by contact with ink or receiving an external force, the second layer 84b is partially detached earlier than the first layer 84a. When the second layer 84b is partially detached over the entire thickness thereof, the first layer 84a is exposed at the partially detached portion. In this state, since the color of the first layer 84a and the color of the second layer 84b are different from each other, it is possible to detect that the second layer 84b has been partially detached at the exposed portion of the first layer 84a. Therefore, before a problem occurs in the liquid ejecting head 1 due to peeling of the first layer 84a caused by swelling, dissolution, scraping, or the like of the first layer 84a, it is possible to detect a state in which the first layer 84a is soon scraped, dissolved, or partially detached. That is, the near-failure state of the first layer 81a can be detected.

When viewed in a direction intersecting the Z-axis which is an example of the “first direction”, the first layer 84a is disposed between the surface F9 which is an outer peripheral surface of the cover 16 and the surface F8 which is an outer peripheral surface of the holder 13. Accordingly, as illustrated in FIG. 10, since the first layer 84a is at a visible position when viewed in the direction intersecting the Z-axis, the near-failure state of the first layer 84a can be easily detected.

Similarly, the second layer 84b is also disposed between the surface F9 and the surface F8 when viewed in the direction intersecting the Z-axis. Thereby, it is possible to visually recognize an exposed portion of the first layer 84a due to partial detachment of the second layer 84b when viewed in the direction intersecting the Z-axis.

### 1-8. Sealing Between Cover and Flow Pipes

FIG. 12 is an explanatory view of the cover 16 and a flow-path tube 11b. FIG. 13 is an explanatory view of the sealing material 85 disposed between the cover 16 and the flow-path tube 11b. As described above, the liquid ejecting head 1 includes the flow-path member 11a, the flow-path tubes 11b, and the cover 16. Here, the sealing material 85 is disposed in the gap between the outer peripheral surface F10 of each flow-path tube 11b and the inner peripheral surface F11 of the corresponding opening 16a of the cover 16. The sealing material 85 is composed of an adhesive such as an epoxy-based adhesive or a silicone-based adhesive.

If the sealing material 85 that seals the gap between the flow-path tube 11b and the opening 16a swells due to ink dripped from the flow-path tube 11b, dissolves, and is lost, an adhesive failure between the flow-path tube 11b and the cover 16 occurs. Further, if the sealing material 85 is scraped, and ink enters the inside of the cover 16, the ink can adhere to electronic components such as a circuit board, for example, the wiring substrate 12, inside the cover 16, causing a failure.

Therefore, the sealing material 85 has a first layer 85a and a second layer 85b. These layers are stacked in the order of the first layer 85a and the second layer 85b from the inside to the outside of the liquid ejecting head 1 in the direction along the Z-axis.

Here, the first layer 85a is covered with the second layer 85b, and thus is not exposed to the outside of the liquid ejecting head 1. In contrast, the second layer 85b is exposed to the outside of the liquid ejecting head 1. The color of the first layer 85a and the color of the second layer 85b are different from each other. The constituent materials and the magnitude relationship of the thicknesses of the first layer 85a and the second layer 85b are the same as those of the first layer 81a and the second layer 81b of the sealing material 81 described above.

With the sealing material 85 described above, since it is possible to detect that the second layer 85b has been scraped in a state where the first layer 85a remains before the above-described adverse influence is exerted, it is possible to detect the near-failure state of the first layer 85a.

The first layer 85a is disposed between the surface F14 of the cover 16 and the surface F13 of the flow-path tube 11b when viewed in the Z2 direction opposite to the Z1 direction which is an example of the “first direction”. Accordingly, as illustrated in FIG. 12, since the first layer 85a is located at a visible position when viewed in the Z2 direction, the near-failure state of the first layer 85a can be easily detected.

Similarly, the second layer 85b is also disposed between the surface F14 and the surface F13 when viewed in the Z2 direction opposite to the Z1 direction. Accordingly, it is possible to visually recognize an exposed portion of the first layer 85a due to partial detachment of the second layer 85b when viewed in the Z2 direction.

Further, the first layer 85a is disposed between the outer peripheral surface F10 and the inner peripheral surface F11. Accordingly, since the first layer 85a is located at a visible position when viewed in the Z2 direction, the near-failure state of the first layer 85a can be easily detected.

Similarly, the second layer 85b is also disposed between the outer peripheral surface F10 and the inner peripheral surface F11. Accordingly, it is possible to visually recognize an exposed portion of the first layer 85a due to partial detachment of the second layer 85b when viewed in the Z2 direction.

### 2. Modification Examples

The embodiment illustrated above may be modified in various ways. Specific aspects of modifications that can be applied to the above embodiment will be illustrated below as examples. Any two or more aspects selected from the following examples as appropriate can be appropriately combined within a range in which they do not contradict each other.

### 2-1. Modification Example 1

In the above-described embodiment, the aspect in which each of the sealing materials 81, 82, 83, 84, and 85 has a two-layer stacked structure is illustrated as an example, but the present disclosure is not limited to this aspect. At least one of the sealing materials 81, 82, 83, 84, and 85 may have a stacked structure with three or more layers. For example, the sealing material 81 may include a third layer disposed between the first layer 81a and the second layer 81b, in addition to the first layer 81a and the second layer 81b. In this case, the color of the third layer is preferably different from both the colors of the first layer 81a and the second layer 81b. Thus, the life of the sealing material 81 can be detected in multiple stages.

### 2-2. Modification Example 2

The above-described embodiment illustrates an example of an aspect in which the sealing material 81 has the first layer 81a and the second layer 81b over the entire periphery of the gap between the outer peripheral surface F3 of each nozzle plate 18c and the inner peripheral surface F4 of the corresponding opening 14a of the fixing plate 14 when viewed in the Z1 direction. However, the present disclosure is not limited to this aspect. The sealing material 81 may have the first layer 81a and the second layer 81b only in a part of the gap between the outer peripheral surface F3 of each nozzle plate 18c and the inner peripheral surface F4 of the corresponding opening 14a. Similarly, when viewed in the Z1 direction, the sealing material 82 may have the first layer 82a and the second layer 82b only in a part of the gap between the outer peripheral surface F5 of the fixing plate 14 and the inner peripheral surface F6 of the recesses 13c of the holder 13. In addition, the sealing material 84 may have the first layer 84a and the second layer 84b only in a part of the gap between the surface F9 which is an outer peripheral surface of the cover 16 and the surface F8 which is an outer peripheral surface of the holder 13 when viewed in a direction intersecting the Z-axis. Further, the sealing material 85 may have the first layer 85a and the second layer 85b only in a part of the gap between the outer peripheral surface F10 of each flow-path tube 11b and the inner peripheral surface F11 of the corresponding opening 16a of the cover 16 when viewed in the Z2 direction.

### 2-3. Modification Example 3

In the above-described embodiment, an aspect in which the liquid ejecting head includes four head chips is illustrated as an example, but the present disclosure is not limited to this aspect. The number of head chips included in the liquid ejecting head may be three or less or five or more. In addition, in a case where the liquid ejecting head includes a plurality of head chips, the arrangement of the plurality of head chips is not limited to the above-described embodiment and may be in any suitable configuration. In addition, the shape of the liquid ejecting head is also not limited to the above-described embodiment and may be in any suitable configuration.

### 2-4. Modification Example 4

In the above-described embodiment, the liquid ejecting apparatus 100 of a serial type in which the transport unit 41 on which the liquid ejecting head 1 is mounted reciprocates in the width direction of the medium M is illustrated as an example, but the liquid ejecting apparatus may be of a line type in which a plurality of nozzles N are distributed across the entire width of the medium M.

### 2-5. Modification 5

The liquid ejecting apparatus illustrated in the above embodiment can be employed in various apparatuses such as facsimile apparatuses and copy machines, in addition to apparatuses dedicated to printing. As a matter of course, applications of the liquid ejecting apparatus are not limited to printing. For example, a liquid ejecting apparatus that ejects a solution of a coloring material is used as a manufacturing apparatus that forms a color filter of a display device such as a liquid crystal display panel. A liquid ejecting apparatus that ejects a solution of a conductive material is used as a manufacturing apparatus that forms wiring or electrodes on a wiring substrate. A liquid ejecting apparatus that ejects a solution of an organic material related to a living body is used as, for example, a manufacturing apparatus that manufactures a biochip.

### 3. Appendices

The present disclosure is summarized as follows.
(Appendix 1) A first aspect which is a preferred example of a liquid ejecting head of the present disclosure is a liquid ejecting head including: a first member; a second member; and a first sealing material disposed between the first member and the second member, in which the first sealing material includes a second layer exposed to an outside of the liquid ejecting head and a first layer not exposed to the outside of the liquid ejecting head by being covered with the second layer, and a color of the first layer and a color of the second layer are different from each other.

In the above aspect, the first layer is covered with the second layer, and the second layer is exposed to the outside of the liquid ejecting head. Therefore, in a case where the first sealing material is partially detached due to swelling or dissolution caused by contact with ink or receiving an external force, the second layer is partially detached earlier than the first layer. When the second layer is partially detached over the entire thickness thereof, the first layer is exposed at the partially detached portion. In this state, since the color of the first layer and the color of the second layer are different from each other, it is possible to detect that the second layer has been partially detached at the exposed portion of the first layer. Therefore, it is possible to detect a state in which the first layer is soon scraped, dissolved, or partially detached before a problem occurs in the liquid ejecting head due to peeling of the first layer caused by swelling, dissolution, scraping, or the like of the first layer. That is, the near-failure state of the first layer can be detected.
(Appendix 2) In a second aspect which is a preferred example of the first aspect, the first member has a first surface facing a first direction, the second member has a second surface facing the first direction, and when viewed in a direction opposite to the first direction, the first layer is disposed between the first surface and the second surface. In the above aspect, since the first layer is located at a visible position when viewed in the direction opposite to the first direction, the near-failure state of the first layer can be easily detected.
(Appendix 3) In a third aspect which is a preferred example of the first aspect or the second aspect, the second member has an inner peripheral surface defining an opening, the first member has an outer peripheral surface disposed on an inner side of the inner peripheral surface, and the first layer is disposed between the outer peripheral surface and the inner peripheral surface. In the above aspect, since the first layer is located at a visible position when viewed in the direction along the central axis of the opening of the second member, the near-failure state of the first layer can be easily detected.
(Appendix 4) In a fourth aspect which is a preferred example of any one of the first aspect to the third aspect, the liquid ejecting head further includes a third member that does not serve as an outer surface of the liquid ejecting head, the first member and the second member serve as an outer surface of the liquid ejecting head, and the first layer is in contact with an adhesive layer provided between the first member and the third member. In the above aspect, when the second layer is peeled, the adhesive layer is still covered with the first layer. Therefore, it can be recognized that the second layer has been peeled before the adhesive layer is exposed to the outside. Therefore, it is possible to prevent a problem such as an ejection failure caused by peeling of the adhesive layer due to adhesion of ink.
(Appendix 5) In a fifth aspect which is a preferred example of any one of the first aspect to the fourth aspect, the liquid ejecting head further includes a second sealing material that is disposed in a gap and whose outer surface is not exposed to the outside of the liquid ejecting head, and the second sealing material is formed of only one layer. In the above aspect, even if the second sealing material which is not exposed to the outside has a two-layer structure with different colors, it is not easy to visually inspect the second sealing material. Therefore, the cost necessary for the second sealing material can be reduced by forming the second sealing material with only one layer.
(Appendix 6) In a sixth aspect which is a preferred example of any one of the first aspect to the fifth aspect, a thickness of the first layer at a position at which a thickness of the first sealing material is smallest is larger than a thickness of the second layer at the position. In the above aspect, when the first sealing material is scraped from the surface of the second layer exposed to the outside to the boundary between the second layer and the first layer at the position where the first sealing material is thinnest, half or more of the thickness of the entire first sealing material still remains. Therefore, before a problem due to peeling of the first layer occurs, it is possible to detect the possibility of the occurrence of the problem at an early stage.
(Appendix 7) In a seventh aspect which is a preferred example of the sixth aspect, the thickness of the first layer is not less than twice the thickness of the second layer. In the above aspect, before a problem due to peeling of the first layer occurs, it is possible to detect the possibility of occurrence of the problem at an early and appropriate time.
(Appendix 8) In an eighth aspect which is a preferred example of any one of the first aspect to the seventh aspect, at least one of the first layer and the second layer contains a coloring agent. In the above aspect, it is possible to easily adjust the degree of difference between the color of the first layer and the color of the second layer by changing the type, content, or the like of the coloring agent.
(Appendix 9) In a ninth aspect which is a preferred example of the eighth aspect, each of the first layer and the second layer includes a coloring agent, and a color of the coloring agent contained in the first layer and a color of the coloring agent contained in the second layer are different from each other. In the above aspect, it is possible to easily adjust the difference between the color of the first layer and the color of the second layer by adjusting the types, the content, or the like of the coloring agents used in the first layer and the second layer.
(Appendix 10) In a tenth aspect which is a preferred example of the eighth aspect, a component of the first layer excluding the coloring agent and a component of the second layer excluding the coloring agent are the same as each other. In the above aspect, the difference in the coefficient of linear expansion between the first layer and the second layer can be substantially eliminated. Therefore, it is possible to prevent peeling of the first sealing material due to the difference in the coefficient of linear expansion. In contrast, as the difference in the coefficient of linear expansion increases, the difference between the amounts of shrinkage of the first layer and the second layer along with curing also increases. Therefore, the first sealing material warps due to the difference between the stresses of the first layer and the second layer, and thus the first sealing material is easily peeled.
(Appendix 11) In an eleventh aspect which is a preferred example of the eighth aspect, the coloring agent is a dye. In the above aspect, since the particles of dyes are smaller than the particles of pigments, it is possible to reduce adverse effects due to the particles of the coloring agent, compared to a case where a pigment is used. Examples of the adverse effects include damage to the wiping member due to adhesion of the particles of the coloring agent, damage to nozzle plates due to the particles of the coloring agent interposed between the wiping member and the nozzle plates, and ejection failures due to the particles of the coloring agent remaining in nozzles.
(Appendix 12) In a twelfth aspect which is a preferred example of any one of the first aspect to the eleventh aspect, at least one of the first layer and the second layer contains a fluorescent material that emits light when irradiated with ultraviolet light. In the above aspect, one or both of the first layer and the second layer can be caused to emit light by irradiating the first sealing material with ultraviolet light. In this state, the difference between the color of the first layer and the color of the second layer can be recognized based on the presence or absence of light emission or the difference in emission color between the first layer and the second layer.
(Appendix 13) In a thirteenth aspect which is a preferred example of any one of the first aspect to the twelfth aspect, a color difference between the color of the first layer and the color of the second layer is not less than 12.0. In the above aspect, the difference between the color of the first layer and the color of the second layer can be easily visually recognized.
(Appendix 14) In a fourteenth aspect which is a preferred example of any one of the first aspect to thirteenth aspect, one of the colors of the first layer and the second layer is a chromatic color, and the other is an achromatic color. In the above aspect, since chromatic colors are distinct while achromatic colors are indistinct, the color of the first layer and the color of the second layer can be easily distinguished.
(Appendix 15) In a fifteenth aspect which is a preferred example of any one of the first aspect to the fourteenth aspect, the liquid ejecting head further includes: a nozzle plate including a nozzle that ejects liquid in an ejection direction; and a fixing plate having an opening for exposing the nozzle, the first member is the nozzle plate, the second member is the fixing plate, and the first sealing material is disposed between the opening and an outer peripheral surface of the nozzle plate.

In the above aspect, since the first sealing material disposed between the nozzle plate and the fixing plate is located close to nozzles, the first sealing material easily swells due to adhesion of ink mist. Further, since the surface of the first sealing material facing the ejection direction is wiped by the wiping member, the first sealing material is likely to be scraped by being rubbed by the wiping member. If the sealing material disposed between the nozzle plates and the fixing plate is scraped, the adhesive between the fixing plate and the head chips is exposed, and the adhesive can swell due to contact with ink, thereby causing an adhesion failure. When such an adhesion failure occurs, the compliance substrate cannot fulfill its role, which can adversely affect the ejection of ink. In addition, if the adhesive between the nozzle plates and the communication plate is exposed, and it causes an adhesion failure due to the adhesive coming into contact with ink, there is a possibility that the ejection of the ink can be adversely affected also in this point. Since it is possible to detect that the second layer has been scraped in a state where the first layer remains before such an adverse effect is exerted, it is possible to detect the near-failure state of the first layer of the first sealing material.
(Appendix 16) In a sixteenth aspect which is a preferred example of any one of the first aspect to the fourteenth aspect, the liquid ejecting head further includes: a flow-path member having a flow path communicating with a nozzle; a flow-path tube that connects the outside of the liquid ejecting head and the flow path; and a cover that houses the flow-path member and has an opening into which the flow-path tube is inserted, the first member is the flow-path tube, the second member is the cover, and the first sealing material is disposed between the opening and an outer peripheral surface of the flow-path tube.

In the above aspect, the sealing material that seals the space between the flow-path tubes and the openings of the cover is dissolved and lost due to swelling caused by the ink dripping from the flow-path tubes, and an adhesion failure between the flow-path tubes and the cover occurs. Further, when the sealing material is scraped and ink enters the inside of the cover, the ink can adhere to electronic components such as a circuit board inside the cover and cause a failure. Since it is possible to detect that the second layer has been scraped in a state where the first layer remains before such an adverse effect is exerted, it is possible to detect the near-failure state of the first layer of the first sealing material.
(Appendix 17) A seventeenth aspect which is a preferred example of the liquid ejecting head of the present disclosure is a liquid ejecting head including: a first member having a through hole; and a first sealing material disposed in the through hole, in which the first sealing material includes a second layer exposed to an outside of the liquid ejecting head and a first layer not exposed to the outside of the liquid ejecting head by being covered with the second layer, and a color of the first layer and a color of the second layer are different from each other.

In the above aspect, the first layer is covered with the second layer, and the second layer is exposed to the outside of the liquid ejecting head. Therefore, in a case where the first sealing material is partially detached due to swelling or dissolution caused by contact with ink or receiving an external force, the second layer is partially detached earlier than the first layer. When the second layer is partially detached over the entire thickness thereof, the first layer is exposed at the partially detached portion. In this state, since the color of the first layer and the color of the second layer are different from each other, it is possible to detect that the second layer has been partially detached at the exposed portion of the first layer. Therefore, before a problem occurs in the liquid ejecting head due to peeling of the first layer caused by swelling, dissolution, scraping, or the like of the first layer, it is possible to detect a state in which the first layer is soon scraped, dissolved, or partially detached. That is, the near-failure state can be detected.

What is claimed is:

1. A liquid ejecting head comprising:
a first member;
a second member; and
a first sealing material disposed between the first member and the second member, wherein
the first sealing material includes
a second layer exposed to an outside of the liquid ejecting head and
a first layer not exposed to the outside of the liquid ejecting head by being covered with the second layer, and
a color of the first layer and a color of the second layer are different from each other.

2. The liquid ejecting head according to claim 1, wherein
the first member has a first surface facing a first direction,
the second member has a second surface facing the first direction, and
when viewed in a direction opposite to the first direction, the first layer is disposed between the first surface and the second surface.

3. The liquid ejecting head according to claim 1, wherein
the second member has an inner peripheral surface defining an opening,
the first member has an outer peripheral surface disposed on an inner side of the inner peripheral surface, and
the first layer is disposed between the outer peripheral surface and the inner peripheral surface.

4. The liquid ejecting head according to claim 1, further comprising
a third member that does not serve as an outer surface of the liquid ejecting head, wherein
the first member and the second member serve as an outer surface of the liquid ejecting head, and
the first layer is in contact with an adhesive layer provided between the first member and the third member.

5. The liquid ejecting head according to claim 1, further comprising
a second sealing material that is disposed in a gap and whose outer surface is not exposed to the outside of the liquid ejecting head, wherein
the second sealing material is formed of only one layer.

6. The liquid ejecting head according to claim 1, wherein
a thickness of the first layer at a position at which a thickness of the first sealing material is smallest is larger than a thickness of the second layer at the position.

7. The liquid ejecting head according to claim 6, wherein
the thickness of the first layer is not less than twice the thickness of the second layer.

8. The liquid ejecting head according to claim 1, wherein
at least one of the first layer and the second layer contains a coloring agent.

9. The liquid ejecting head according to claim 8, wherein
each of the first layer and the second layer includes a coloring agent, and
a color of the coloring agent contained in the first layer and a color of the coloring agent contained in the second layer are different from each other.

10. The liquid ejecting head according to claim 8, wherein
a component of the first layer excluding the coloring agent and a component of the second layer excluding the coloring agent are the same as each other.

11. The liquid ejecting head according to claim 8, wherein
the coloring agent is a dye.

12. The liquid ejecting head according to claim 1, wherein
at least one of the first layer and the second layer contains a fluorescent material that emits light when irradiated with ultraviolet light.

13. The liquid ejecting head according to claim 1, wherein
a color difference between the color of the first layer and the color of the second layer is not less than 12.0.

14. The liquid ejecting head according to claim 1, wherein
one of the colors of the first layer and the second layer is a chromatic color, and the other is an achromatic color.

15. The liquid ejecting head according to claim 1, further comprising:
a nozzle plate including a nozzle that ejects liquid in an ejection direction; and
a fixing plate having an opening for exposing the nozzle, wherein
the first member is the nozzle plate,
the second member is the fixing plate, and
the first sealing material is disposed between the opening and an outer peripheral surface of the nozzle plate.

16. The liquid ejecting head according to claim 1, further comprising:
a flow-path member having a flow path communicating with a nozzle;
a flow-path tube that connects the outside of the liquid ejecting head and the flow path; and
a cover that houses the flow-path member and has an opening into which the flow-path tube is inserted, wherein
the first member is the flow-path tube,
the second member is the cover, and
the first sealing material is disposed between the opening and an outer peripheral surface of the flow-path tube.

17. A liquid ejecting head comprising:
a first member having a through hole; and
a first sealing material disposed in the through hole, wherein
the first sealing material includes
a second layer exposed to an outside of the liquid ejecting head and
a first layer not exposed to the outside of the liquid ejecting head by being covered with the second layer, and
a color of the first layer and a color of the second layer are different from each other.
